(19) United States
(12) Patent Application Publication
(10) Pub. No.: US 2007/0276526 A1
(43) Pub. Date: Nov. 29, 2007

(54) Construction element form and method of fabricating same

(76) Inventor: Thor Swanson, Bensenville, IL (US)

Correspondence Address: Glenn B. Foreman, P.O. Box 577, Rayne, LA, 70578, US

(21) Appl. No.: 11/441,686

(22) Filed: May 26, 2006

(51) Int. Cl. G06F 19/00

(52) U.S. Cl. 700/95; 700/97

(57) ABSTRACT

A portable and re-usable form for molding construction panels, and a method for fabricating such a form, including, but not limited to, exterior and interior wall panels, columns, and roof panels is provided. The form includes a frame made from frame members which are precision fitted together utilizing corresponding tabs and slots machined into the frame members and held together with bolts or pins. Additional frame members may be positioned inside of the form to provide spaces for window or door frame installation and electrical conduits. A patterned liner may be placed into the form to produce a pattern on the surface of the construction panel. The form may be assembled at a job site and filled with light weight concrete, cellular concrete, concrete or other pourable construction material. When cured, the form is dis-assembled by removing the bolts or pins, freeing the construction panel which can be then placed into position and used to form a section of a structure.

### TECHNICAL FIELD

This invention relates generally to building construction and more particularly to the fabrication of forms for the molding of precision construction panels that are positioned into place and attached to form a structure or parts of a structure.

### BACKGROUND

Forms for the construction of buildings have been used for years. In general, these forms are built on site, filled with concrete, and, after the concrete cures, the form is disassembled, and discarded after use. This process is wasteful of both time and materials, and has the further disadvantage of lacking precision, and detail for all but the most basic kinds of construction elements. Where metal forms have been used, they have been made utilizing methods which limit the precision and detail required for the versatility needed in a complete construction system. Furthermore, these prior art forms do not allow for the integration of such elements as window and door frames, joint seals, electrical boxes and conduits, archways, or pattern texturing, all of which are labor intensive processes which add to the cost of construction after the basic forming process is completed. An improved method of fabricating forms for such construction panels that are versatile, portable, and re-usable, and that have the ability to incorporate all of the precision detail of these afore mentioned elements into the finished panel is, needed. It is to the provision of such a form that provides these enhancements, and the method of construction of such a form, that the present invention is primarily directed.

### SUMMARY OF THE INVENTION

Briefly described, the present invention, in a preferred embodiment thereof, comprises an improved form for fabricating concrete, lightweight concrete, or other poured construction material panels, and an improved method for fabricating such a form. The form, generally, depending on the construction panel for which it is intended is comprised of metal or other suitably strong frame members which are machined to precise tolerances utilizing computer controlled cutting machines such as lasers, water jet, or other similar precision computer controlled cutting machinery. These frame members are cut from structural tubing of suitable precise dimensions in order to negate the need for additional reinforcement to resist the substantial pressures created by the concrete or other construction material poured into the form. The form also includes metal plates which are precision cut, similarly using computer controlled precision cutting machines such as lasers, plasma, water jet, or other precision machining methods for cutting plate to close dimensional tolerances that will be familiar to those skilled in the art of metal fabrication and machining. These metal plates and metal tubing frames are precision machined in such a manner that they can be assembled quickly and efficiently onsite utilizing standard assembly methods of bolts and nuts, tabs, slots and pins, and other such standard methods of assembling metal elements. Some elements which require permanent assembly may be welded together rather than utilizing other attachment means. Some of the metal plates are machined in such a way as to fit together precisely forming a matrix for the bed of the form, therefore allowing disassembly of the form into smaller and more portable sections, yet allowing tight enough joints in the matrix to prevent the pourable construction material from leaking through the form. The sides of the form are precisely cut to allow them to be attached to the bed of the form and be held in place by easily removable pins. The side elements are comprised of plate which is reinforced with structural tubing in order to resist the pressure of the construction material, and to allow the attachment of formed plate elements to be removably attached to the interior of the side of the form in order to create a lap or rabbet joint in the finished construction panel for fitting one panel together with another panel in either an inline or right angle configuration with each other. These formed plate elements are reversible on either side of the form in order to provide for versatility in fitting multiple panels together. The bottom and top elements of the form are similarly constructed of precision cut plate and structural tubing elements which allow them to be attached to the bed of the form and to the side elements by utilizing tabs through provided slots and easily removable pins. The bottom and top elements are provided with precision cut holes for the placement of electrical conduit and switch box assemblies. The bottom and top elements are likewise provided with precision cut holes for the placement of removable tubing to extend through the form from bottom to top, thereby creating a negative cavity extending through the finished panel for running a threaded rod or other connecting means in order to attach the panel to a foundation, another panel which can be placed above, or other construction elements such as sills or joists. Strips of precision cut metal plate are provided and are capable of being attached in a variety of configurations to create a groove around the perimeter of the panel in which a sealer material can be placed in order to allow multiple panels to be assembled in a weather tight manner. Provision is made in the top frame member for the positioning and placement of lifting eyes which can be used to lift the finished panel into position by a crane or other lifting means. In the preferred embodiment, a negative space is created in the form for a standard arched window by providing for precision cut frame members which assemble together and can be positioned and attached magnetically at any desired location within the form where a standard window of similar shape and size is desired. While a window frame is shown in the preferred embodiment, it can be easily seen by one skilled in the art that any negative space such as door frames, alcoves, archways, or the like can be created by similar means, and the frame members can be precisely cut and positioned to provide for virtually any negative cavity desired to be created in the finished panel. In the preferred embodiment, a liner can be placed in the bed of the form in order to provide a pre-finished texture to the finished panel when it is removed from the form.

In another preferred embodiment, the basic form as heretofore described is further provided with a horizontal unloading system which allows the cured panel to be unloaded by tilting the hinged pivoting unloading system utilizing a jack or other lifting means without the necessity of having a crane or other heavy construction equipment positioned to unload the cured panel. This unloading system is portable and can be assembled onsite into a rigid framework comprised of precision machined metal structural tubing and metal plate which is held together by bolts or other conventional attachment means. The horizontal unloading system serves as a support base for the basic form during the pouring and curing process.

In yet another preferred embodiment, a form is made utilizing the same method of precision cutting of metal plate material into a plurality of stackable plates such that when stacked and secured together by pins and bolts, the interior cavity formed by the stacked plates is of columnar shape and can be used as a form for pouring concrete or other pourable construction material to create a contoured construction element such as the column in this preferred embodiment, but it can be readily seen that a form for casting virtually any contoured construction element can be created by this method.

### BRIEF DESCRIPTION OF THE DRAWINGS

FIG. 1 is a perspective view of a frame tube assembly used in a support bed assembly for a first preferred embodiment.

FIG. 1a is a close-up perspective detail exploded view of a portion of the frame tube assembly of FIG. 1, showing details of a special weld-nut attachment.

FIG. 1b is a close up perspective detail view of a portion of the frame tube assembly of FIG. 1, showing details of a special weld-nut attachment.

FIG. 2 is a perspective view of a frame rail of the support bed assembly, showing pivoting brackets attached, used in a second preferred embodiment which includes a horizontal unloading platform.

FIG. 3 is a perspective view of the support bed frame assembly, showing the frame tubes assembled to the frame rails, and the pivoting brackets attached, used in the horizontal unloading platform of the second preferred embodiment.

FIG. 3a is a detail exploded view showing a portion of the support bed frame assembly of FIG. 3, illustrating the assembly of the frame tubes to the frame rails.

FIG. 3b is a perspective view of a support bed frame assembly used in a first preferred embodiment of the invention.

FIG. 4 is a perspective view of a side roller rail assembly used in the horizontal unloading platform embodiment.

FIG. 4a is a detail exploded view showing a portion of the side roller rail assembly of FIG. 4, illustrating the detail of the roller assembly.

FIG. 5 is a perspective view of a lower frame brace assembly used in the horizontal unloading platform embodiment.

FIG. 6 is a perspective view of an upper frame brace assembly used in the horizontal unloading platform embodiment.

FIG. 7 is a perspective view of the horizontal unloading platform base frame.

FIG. 7A is a detail exploded view showing a portion of the horizontal unloading platform base frame, illustrating the attachment of the lower frame base assembly to a side roller rail assembly.

FIG. 8 is a perspective view of the complete horizontal unloading platform assembly.

FIG. 8A is a detail exploded view showing a portion of the horizontal unloading platform assembly, illustrating the attachment of the support bed frame assembly of FIG. 3 to the horizontal unloading platform base frame of FIG. 7.

FIG. 9 is a perspective view of the horizontal unloading platform assembly of FIG. 8 with a matrix of casting bed plates attached to the support bed frame assembly.

FIG. 10 is a perspective view showing a casting bed including a matrix of casting bed plates attached to the support bed frame assembly of FIG. 3b, illustrating the use of the support bed frame assembly being supported by leveling jacks.

FIG. 11 is a perspective view of a form side wall assembly shown from the exterior side.

FIG. 12 is a perspective view of a form end wall assembly shown from the exterior side.

FIG. 12A is a perspective view of a form end wall assembly shown from the interior side.

FIG. 13 is a perspective view of a form lap joint assembly.

FIG. 13A is a detail exploded view of a portion of the form lap joint assembly illustrating the method of assembly thereof.

FIG. 14 is a perspective view of an assembled form of a first preferred embodiment, illustrating the attachment to the support frame and casting bed of FIG. 10, of two opposing form end wall assemblies, two opposing form side wall assemblies, and two opposing form lap joint assemblies in a typical configuration to create a basic form for a wall panel.

FIG. 14A is a detail exploded view of a portion of the form of FIG. 14, illustrating the assembly method of a form end wall assembly, a form side wall assembly, and a form lap joint assembly to the support frame and casting bed of FIG. 10.

FIG. 14B is an exploded view illustrating how a liner fits into the form of FIG. 14.

FIG. 15 is a perspective view of a window frame form bottom panel assembly.

FIG. 16 is a perspective view of a window frame form right side panel assembly.

FIG. 17 is a perspective view of a window frame form left side panel assembly.

FIG. 18 is a perspective view of a window frame form top arch panel assembly.

FIG. 19 is a perspective view of a window frame form cross brace assembly.

FIG. 20 is perspective view of a window frame form arch key assembly.

FIG. 21 is a perspective view of a window frame form spanner brace assembly.

FIG. 22 is a perspective view of an assembled window frame form used to produce a cavity for a standard window frame in the preferred embodiment of the invention.

FIG. 23 is a perspective view of an electrical box and conduit assembly used in the preferred embodiment of the invention.

FIG. 24 is a perspective view of a bracket used to position a sliding adjustable electrical box holding assembly for the electrical box and conduit assembly of FIG. 23.

FIG. 25 is a perspective view of a sliding adjustable electrical box holding assembly for the electrical box and conduit assembly of FIG. 23.

FIG. 26 is a perspective view of a first preferred embodiment showing all of the components of the form assembled and positioned on the support frame assembly of FIG. 3B as this preferred embodiment would be positioned and assembled prior to pouring the concrete or other pourable material into the form.

FIG. 27 is an exploded perspective view of a portion of a third preferred embodiment of the invention used as a form for pouring three dimensional construction elements, in this case, a column with a square base.

FIG. 28 is a perspective view of a third preferred embodiment of the invention used as a form for pouring three dimensional construction elements, in this case, a column with a square base.

FIG. 28A is an exploded view of the third preferred embodiment, illustrating the assembly method for a form designed for pouring three dimensional elements, in this case a column with a square base.

FIG. 29 is a perspective view of an improved form end wall assembly which allows the length of the wall panel to be varied by selecting the placement of the assembly in the form configuration.

FIG. 30 is a flowchart diagram showing the steps in the method of fabricating a form of the current invention.

### DETAILED DESCRIPTION OF THE PREFERRED EMBODIMENTS

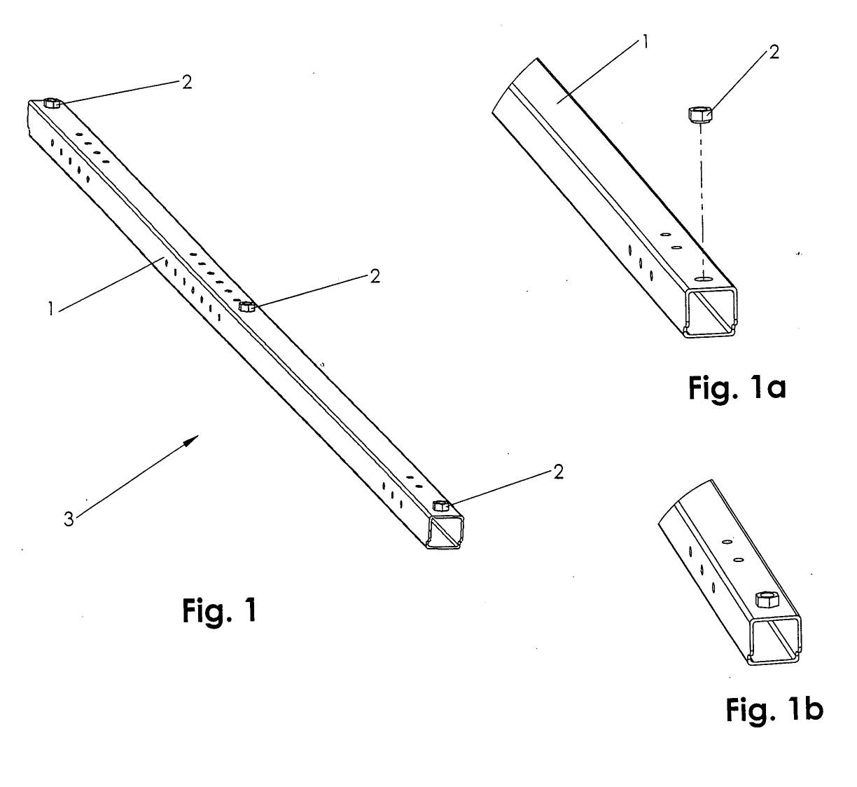

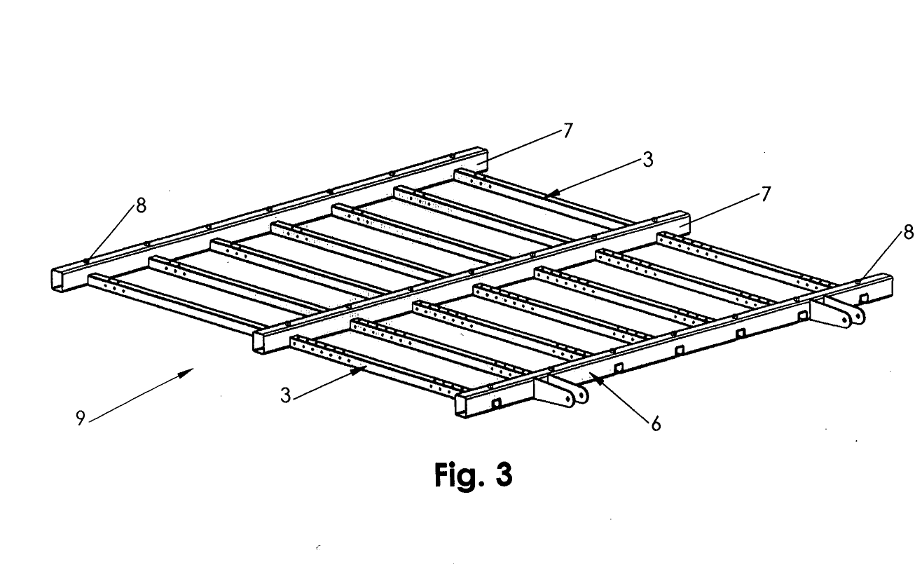

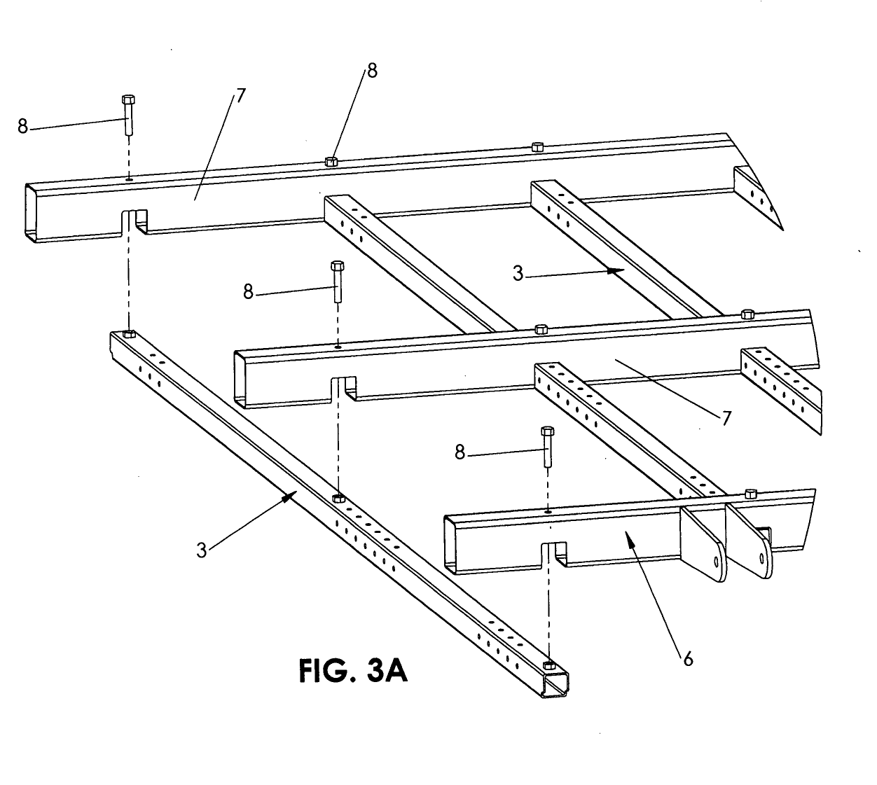

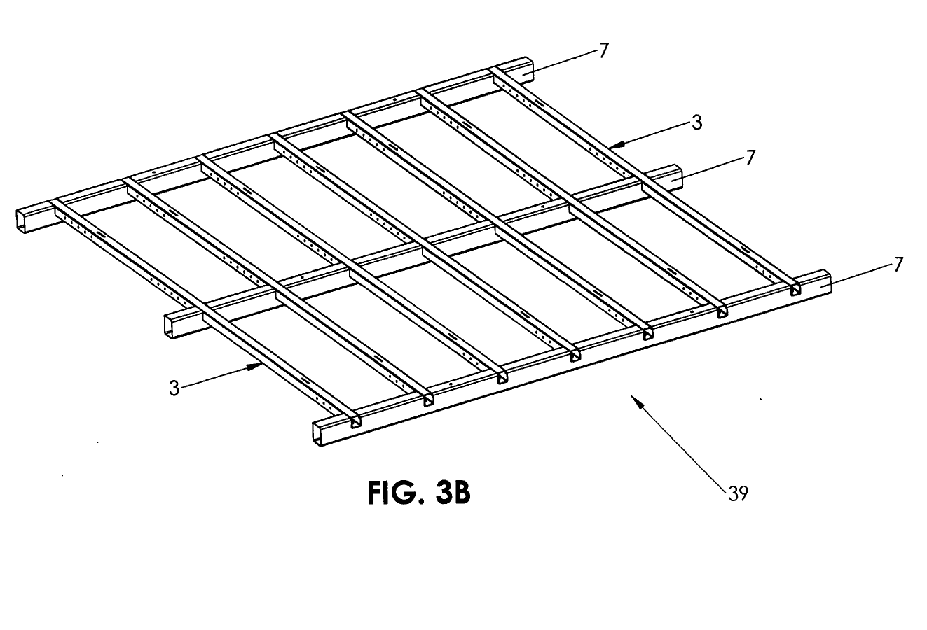

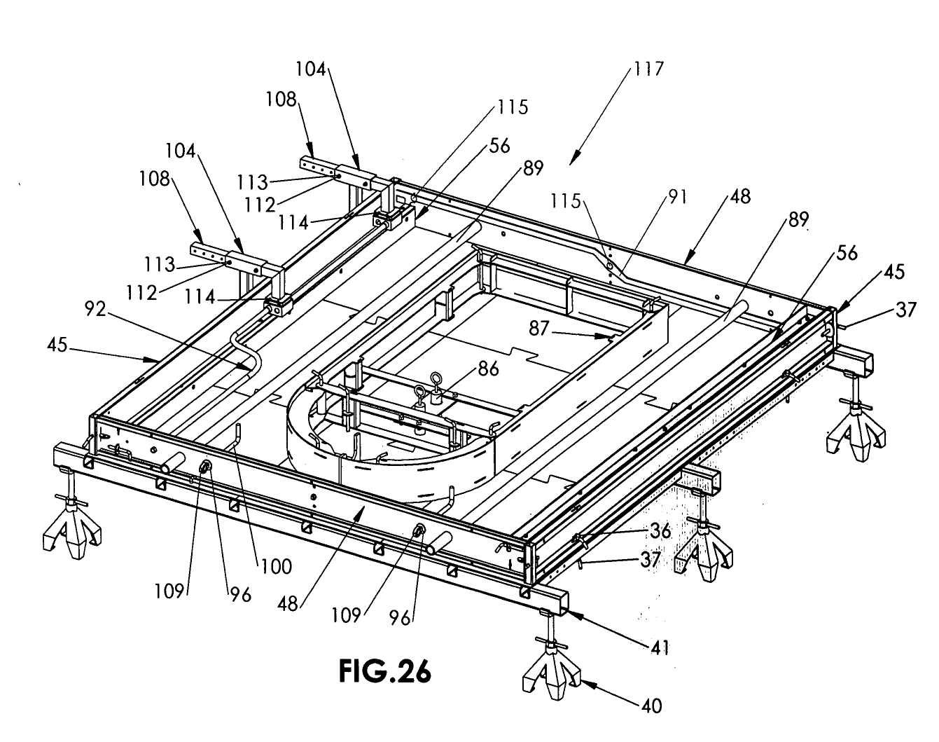

Referring now in more detail to the drawings, in which like reference numerals refer to like parts throughout the several views, FIG. 26 illustrates a first preferred embodiment of a construction panel form for a wall section. The form 117 includes a combination of many individual members using precision machined interlocking members, along with symmetrically interchangeable positional members, forming an enclosure, to define an area and volume precisely, and which can be disassembled for portability, reassembled rapidly, poured onsite, de-molded, and reconfigured quickly for another pouring, and be re-used in the same or different configuration many times over, all as is described in this specification. The use of computer controlled machining such as computer controlled laser machining, computer controlled water jet machining, computer controlled plasma machining, or similar cutting technologies, familiar to one skilled in the art, to machine the individual members of the form is of key importance to the invention, as it allows for the precise fit necessary to contain the poured construction material without leakage, and it allows for the assembly of the members in a variety of configurations, as well as for the de-molding, the re-usability, and the portability of the form. The form 117 illustrated in FIG. 26 is assembled from other assemblies of this preferred embodiment. A plurality of leveling jacks 40 provide a level support surface for the form to insure a level form for pouring and to provide adequate support for the weight of the form and the weight of the poured material. The support bed frame assembly 39 rests on top of the leveling jacks 40. Referring to FIG. 3B, the support bed frame assembly 39 includes precision machined frame tube assemblies 3 which are machined from structural tubing, preferably steel, or of other material strong enough to bear the weight of the form plus the weight of the material to be poured into the form. These frame tube assemblies 3 are dimensionally specific to correspond to the precision machined geometries of the frame rails 7 to provide a precise fit so that when assembled, they provide a strong rigid structure. The frame tube assemblies 3 are attached to the frame rails 7 by tightening bolts 8 through precisely positioned holes in frame rails 7 into precisely positioned nuts 2 in frame tube assemblies 3 as shown in FIG. 3A. The detail of the construction of the frame tube assembly 3 is shown in FIG. 1, FIG. 1A and FIG. 1B, particularly illustrating the positioning and attachment of the special weld nuts 2 into the frame tube 1 to form the frame tube assembly 3. Referring again to FIG. 3B, the frame rails 7 are likewise precision machined from a suitable material, preferably steel, to receive the frame tube assemblies 3 in accurate alignment to produce the support bed frame assembly 39 which in use is supported on a level surface provided in the preferred embodiment by leveling jacks 40.

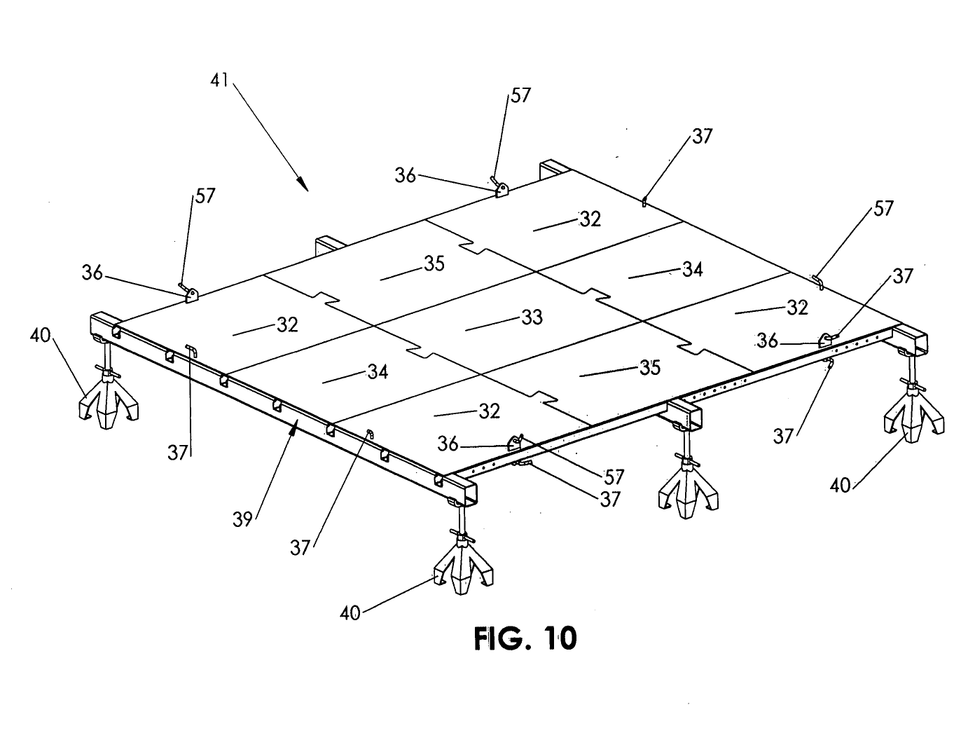

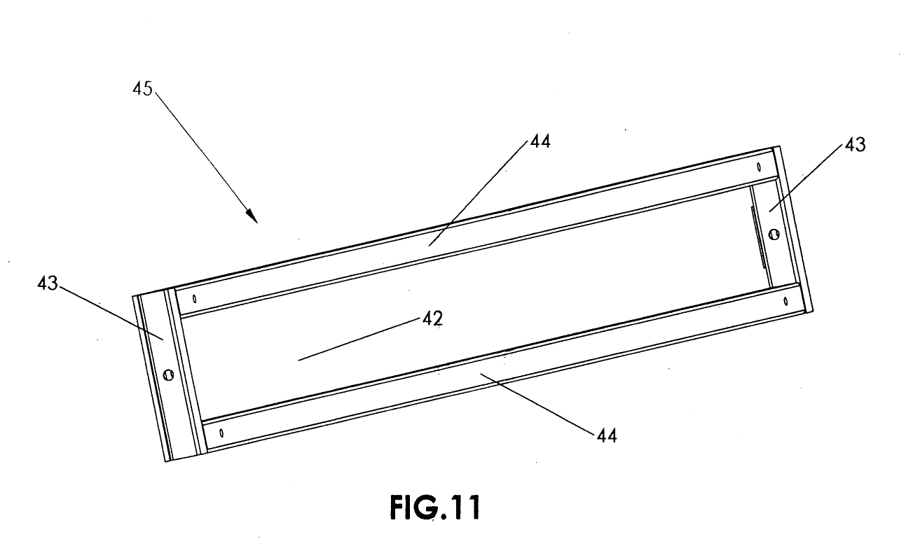

Referring now to FIG. 10, a casting bed 41 is constructed by overlaying the support bed frame assembly 39 with a matrix of interlocking plates 32, 33, 34 and 35 which are precisely machined from a suitably strong material, preferably steel or other strong metal plate material in such a way as to allow the plates to interlock with each other such as with the dovetail geometry illustrated, or other such geometry which lock the plates together. The corner plates 32 are held in correct position and alignment with positioning plates 36 which protrude through precision machined slots in plates 32 and frame tubes 3 and then held in place by alignment pins 37 and 57. It can be seen that a variety of other suitable attachment means could be used to position and affix the casting bed plates to the support bed frame, such as clamps, bolts, or other means familiar to one skilled in the art. The use of precision machining methods such as computer controlled laser cutting or computer controlled water jet cutting or other computer controlled machining methods to machine plates 32, 33, 34 and 35 are essential to provide a matrix of these plates where the joint between them is tight enough to prevent the construction material from leaking through, but may allow moisture to bleed through the joints. It can be seen also that because of the way that these components are made and assembled, that they can be just as easily disassembled for transporting and reassembled for reuse.

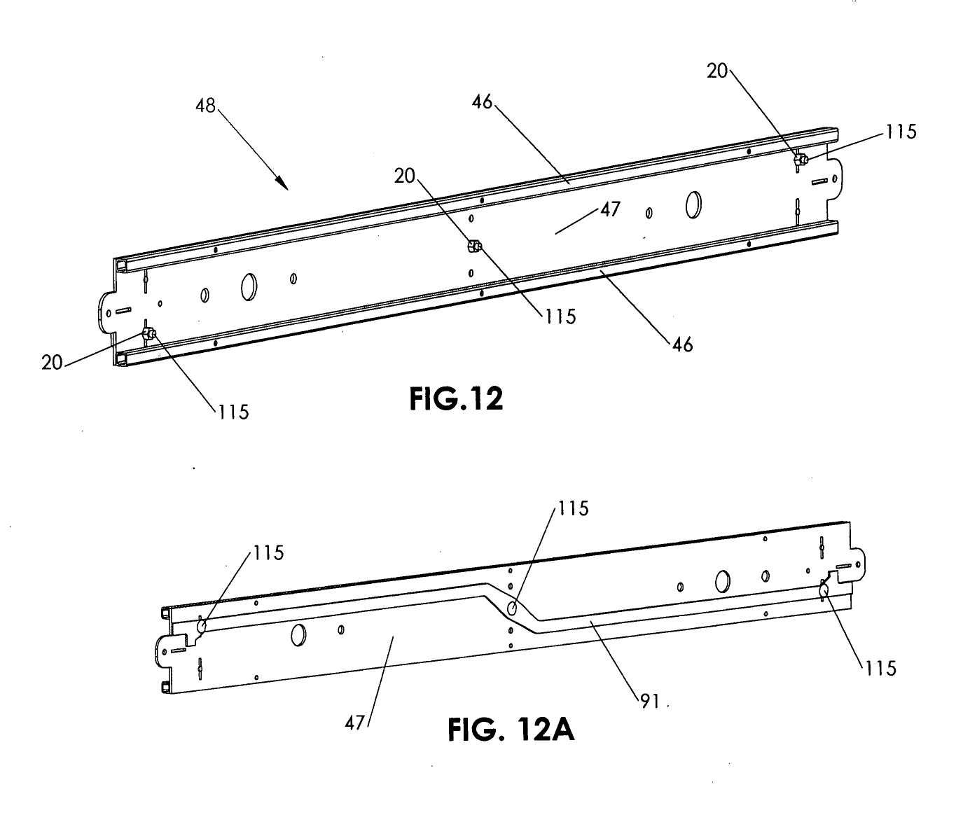

Referring to FIG. 11, a form side wall assembly 45 is shown as constructed from suitable plate material 42, preferably steel or other strong material, precision machined to a length and width required for the height and depth of the desired finished construction element to be molded from the form. This plate material is then reinforced against deformation from the pressure of the poured material by welding or otherwise attaching precision machined reinforcing braces 43 and 44 of an adequately strong and rigid material such as steel tubing or other rigid material to plate 42. In a similar manner, as illustrated in FIG. 12 and FIG. 12A, a form end wall assembly 48 is constructed from a precision machined plate 47 and reinforced with attached reinforcing braces 46. This form end wall assembly 48 is provided with precisely machined and positioned holes for insertion of other features to be described later in this specification. Additionally as shown in FIG. 12A, a groove forming strip 91 can be removably attached to the interior of the form end wall assembly to create a groove for the placement of a sealer strip or bead in the finished construction panel so that when two finished panels are placed together, a weathertight seal can be had between them. As can be seen in FIG. 12A, the groove forming strip 91 is shaped to provide a groove going from one corner of the finished panel to the diagonally opposite corner of the panel, but it can be easily seen that the strip could be made and constructed to go straight across, or could be flipped over to go from the other diagonals of the finished panel, thereby allowing for any combination of joints between panels to be provided with a weathertight seal. The groove forming strip 91 is positioned to the plate 47 by removable fasteners such as bolts 115 and opposing nuts 20.

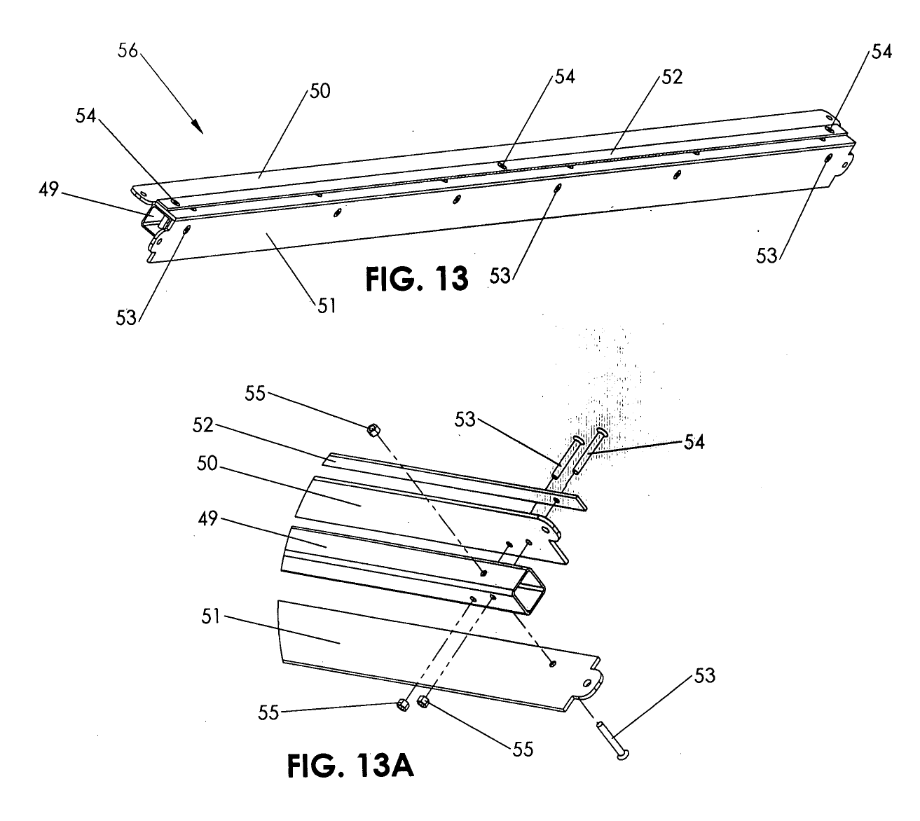

Referring to FIG. 13, a form lap joint assembly 56 is constructed from precision machined plates 50 and 51, and a groove forming strip 52, attached to precision machined tube 49 by bolts 53 and nuts 55. The detail of the precision machined alignment holes can be seen in FIG. 13A.

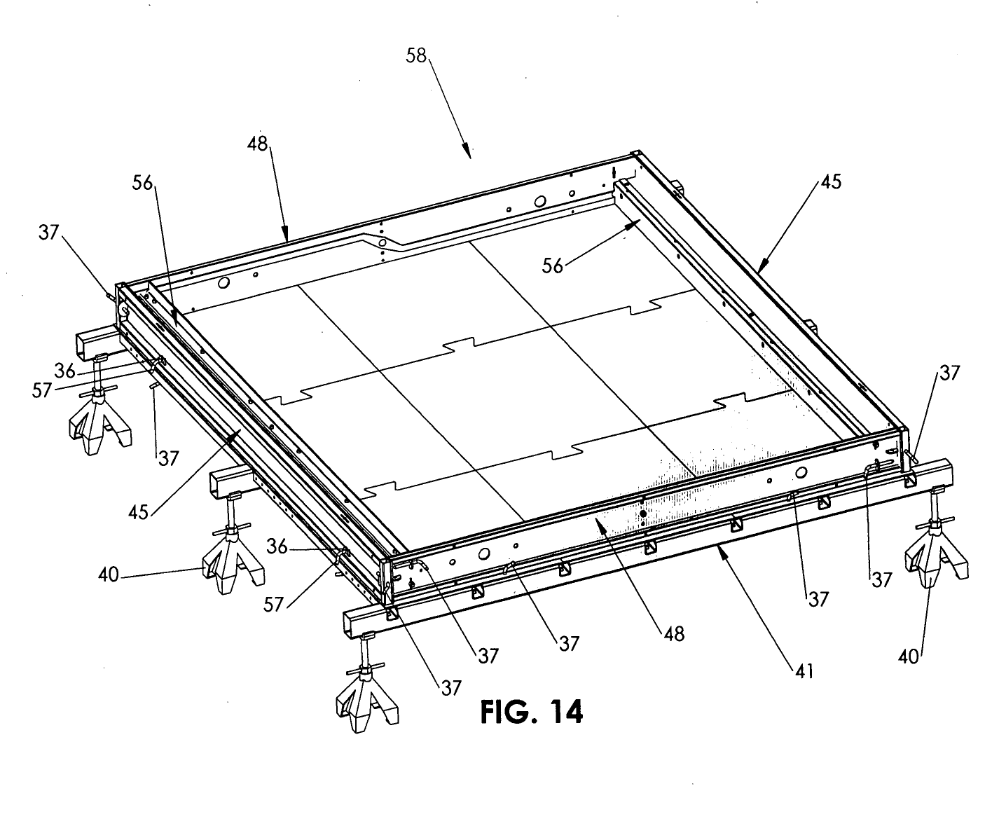

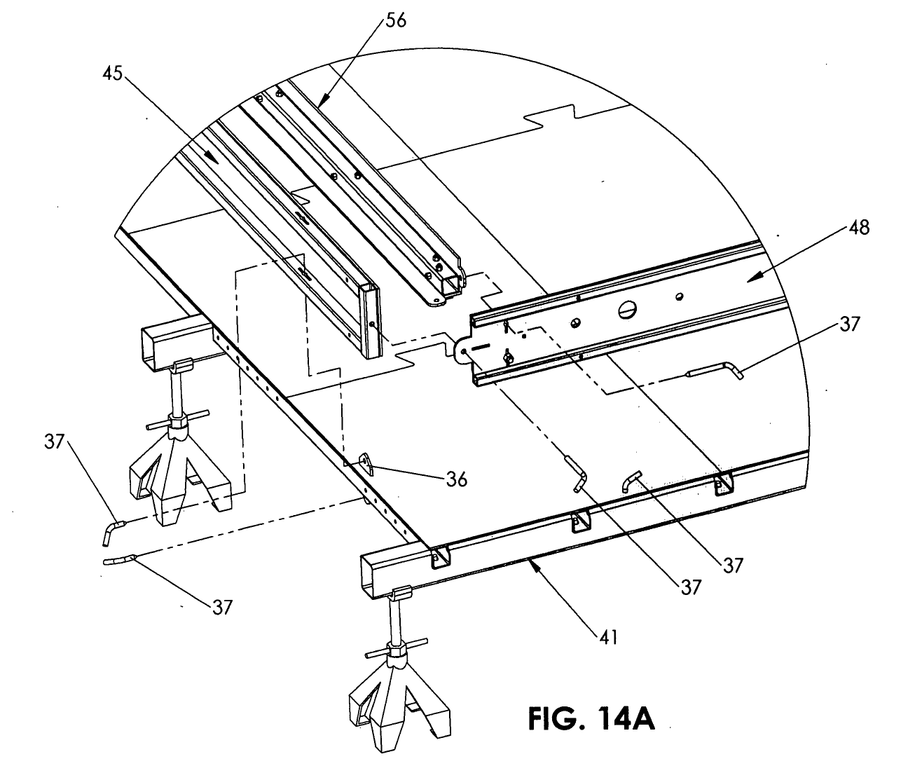

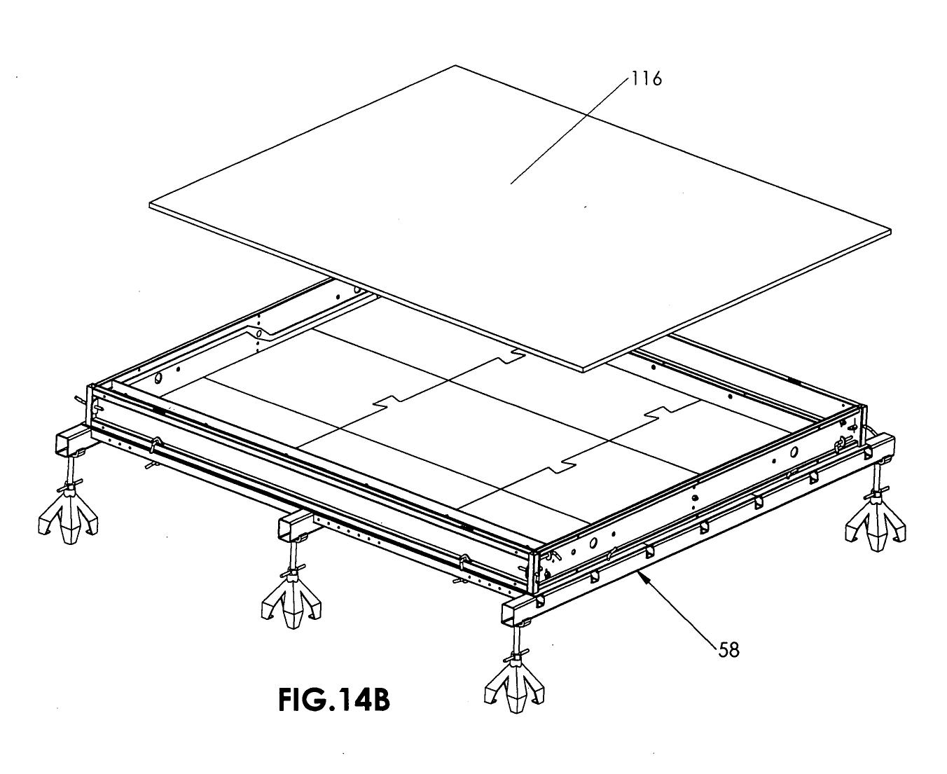

Referring now to FIG. 14, a pair of form side wall assemblies 45 is positioned opposite each other, plate sides facing inward, at each end of casting bed 41. In a similar manner, a pair of form end wall assemblies 48 is positioned opposite each other, plate sides facing inward, at top and bottom of casting bed 41. A pair of form lap joint assemblies 56 is positioned opposite each other at each end of casting bed 41 and inside of the form side wall assemblies. Each form lap joint assembly can be positioned facing either toward the casting bed or toward the open end of the form to create a lap joint facing in the desired direction according to the desired manner of joining the panel being currently cast to an adjoining panel. The form lap joint assemblies are thus reversible, thereby increasing the versatility of the form, which is one of the key features of the preferred embodiment of the invention. The precision machined holes and slots provided in the form side wall assemblies 45, form end wall assemblies 48, and form lap joint assemblies 56, allow these components to interlock with each other and with the casting bed 41, and to be rigidly held in place with alignment pins 37. This can be more clearly seen in FIG. 14A. As can be appreciated from this description, these assemblies can be easily disassembled for demolding and transport and reassembled for reuse. FIG. 14B illustrates how a liner 116 can be used by placing it inside the form on the casting bed. The liner can be a synthetic or natural material having a pattern or texture on the upper surface which when removed will leave a reverse of the pattern or texture on the finished molded panel. The liner could also be simply a smooth impervious material to leave a smooth surface on the molded panel.

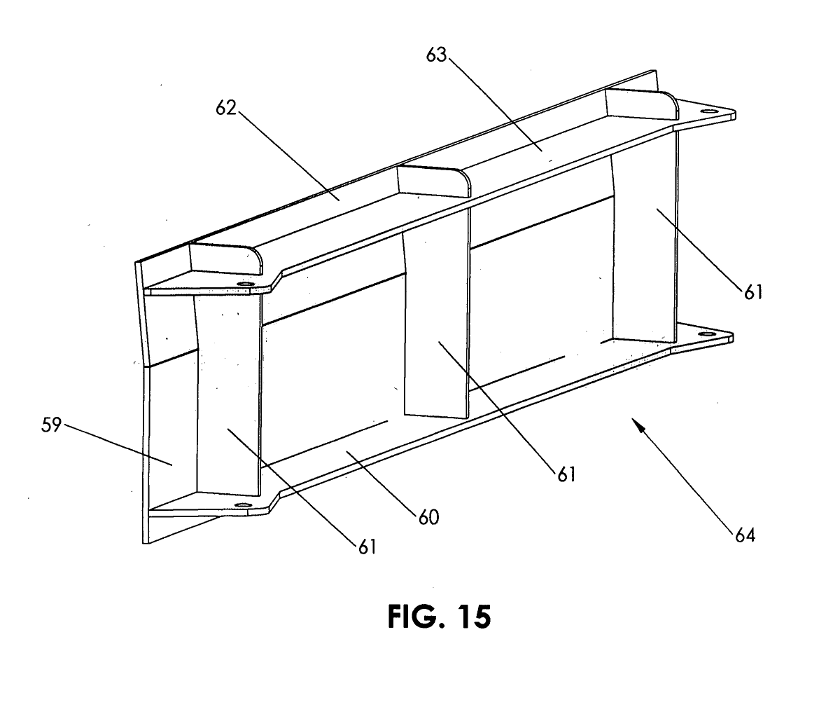

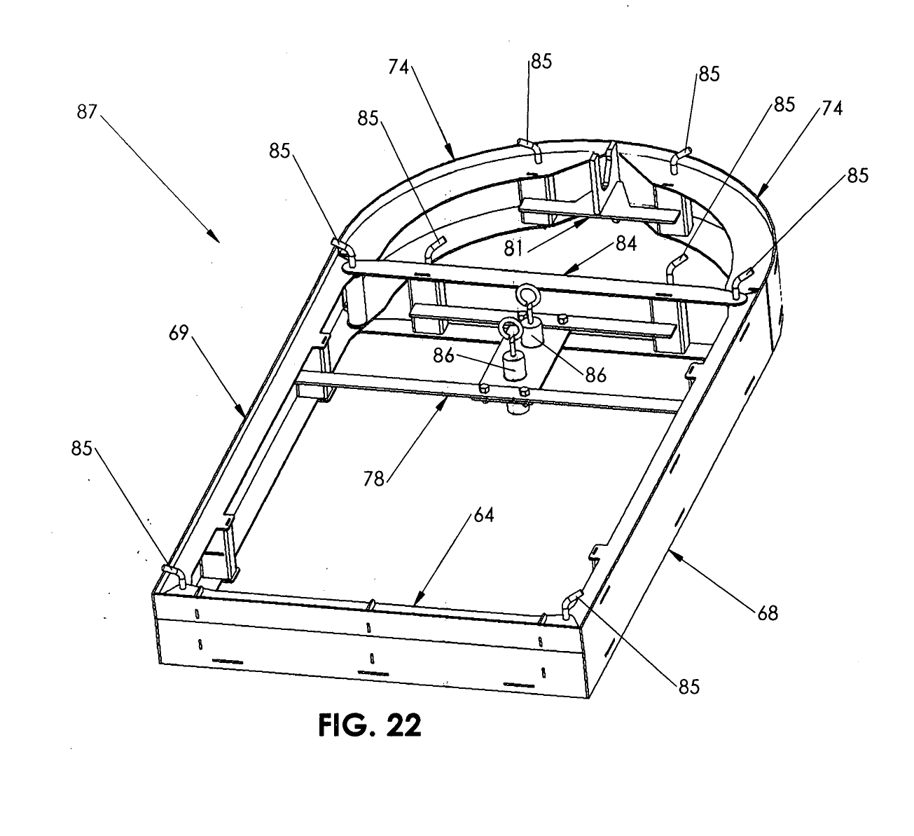

In order to incorporate internal features into a finished panel, additional form elements can be used to provide precisely sized openings for window frames, door frames, or any other features which will be familiar to one skilled in the art. In this first preferred embodiment, an internal feature is provided for a standard sized prefabricated arched window. Referring to FIG. 22, this feature is provided by a precisely sized and assembled window frame form 87 which is designed to allow it to be placed at any desired location within the form and held in place secured to the casting bed in the preferred embodiment by magnets 86. Again, all of the elements of the window frame form are precision machined in order to allow accurate and rapid assembly utilizing common fasteners such as pins, bolts and clamps. In the preferred embodiment, the window frame form 87 includes a window frame form bottom panel assembly 64, a window frame form right side panel assembly 68, a window frame form left side panel assembly 69, two window frame form top arch panel assemblies 74, a window frame form cross brace assembly 78, a window frame form spanner brace assembly 84, and a window frame form arch key assembly 81, all fastened together and held rigidly in place by alignment pins 85. In operation, it can be seen that the form can be held in place in any location in the form by placing the magnets 86 through the cross brace assembly 78. The cross brace assembly 78 and the spanner brace assembly 84 serve to hold the window frame form in perfect alignment. The method of assembly allows the form to be removed easily from the form once the construction material has been molded and set by removing the alignment pins 85 and then breaking down the window frame form piece by piece inwardly away from the molded panel. While the preferred embodiment shows the use of a window frame form, it can be easily seen by one skilled in the art that a similar form could be constructed using the same methods to provide any internal feature desired such as door frames, alcoves, archways, insets, or virtually any other feature. To illustrate in further detail the features of the window frame form 87 of the preferred embodiment, refer now to FIG. 15 which illustrates the construction of the window frame form bottom panel assembly 64. Precision machined members are again utilized to provide a very precise fit of the members of the window frame form bottom panel assembly 64 with each other, and with the other panel assemblies with which it will be assembled to form the finished window frame form. A suitable plate material, in this embodiment, steel plate, is used and is precision cut using computer controlled laser cutting, water jet cutting, or other precision cutting machinery.

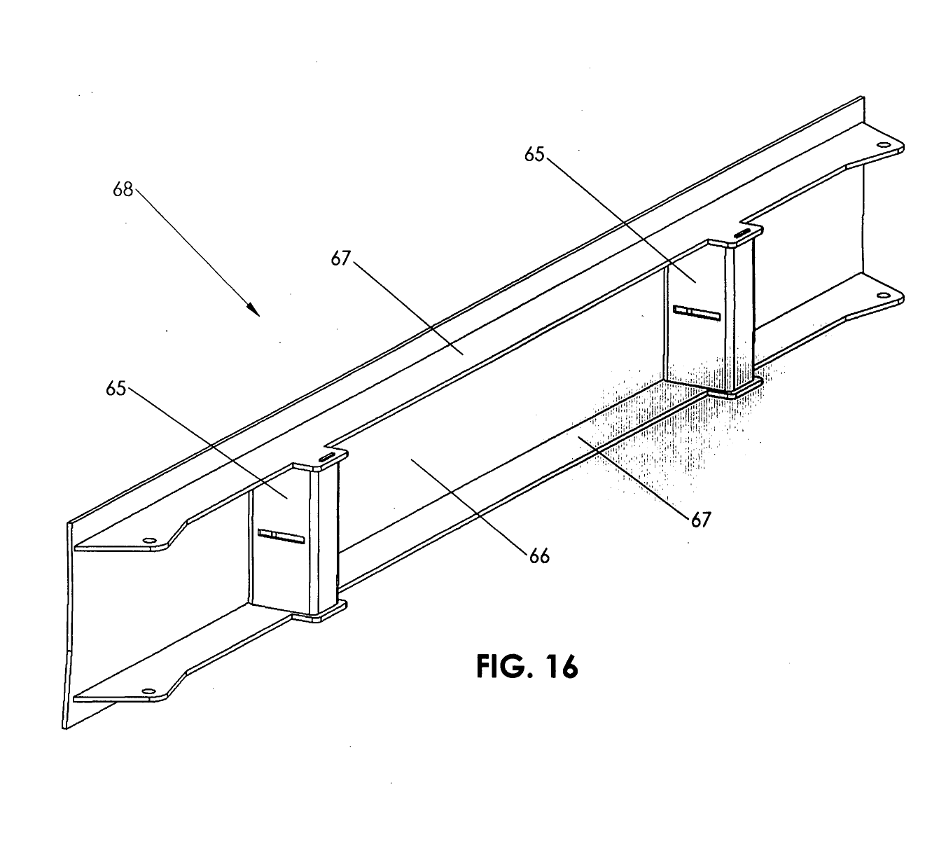

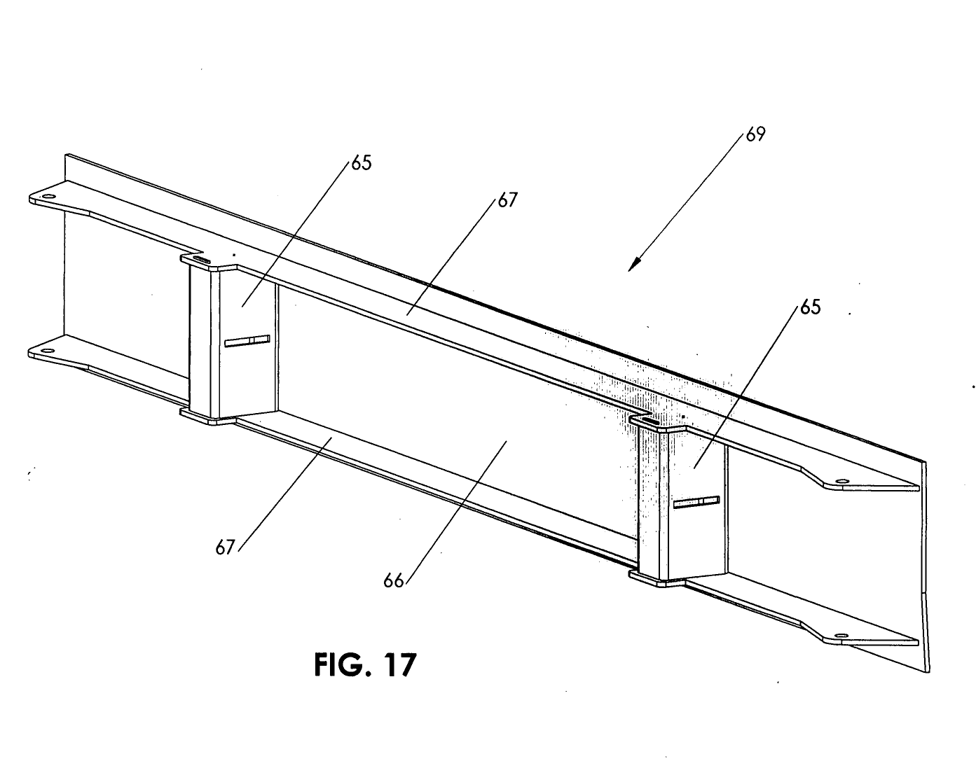

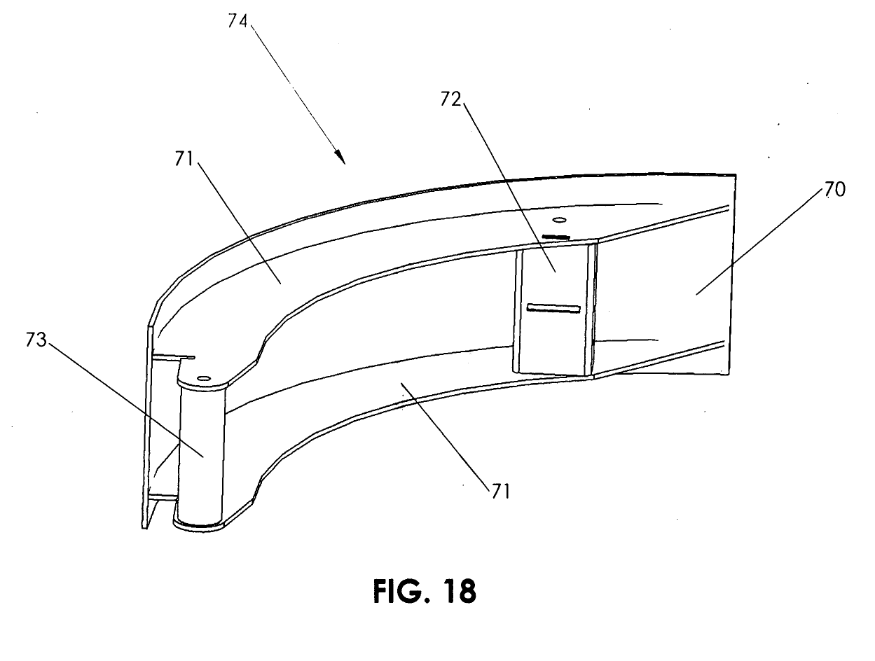

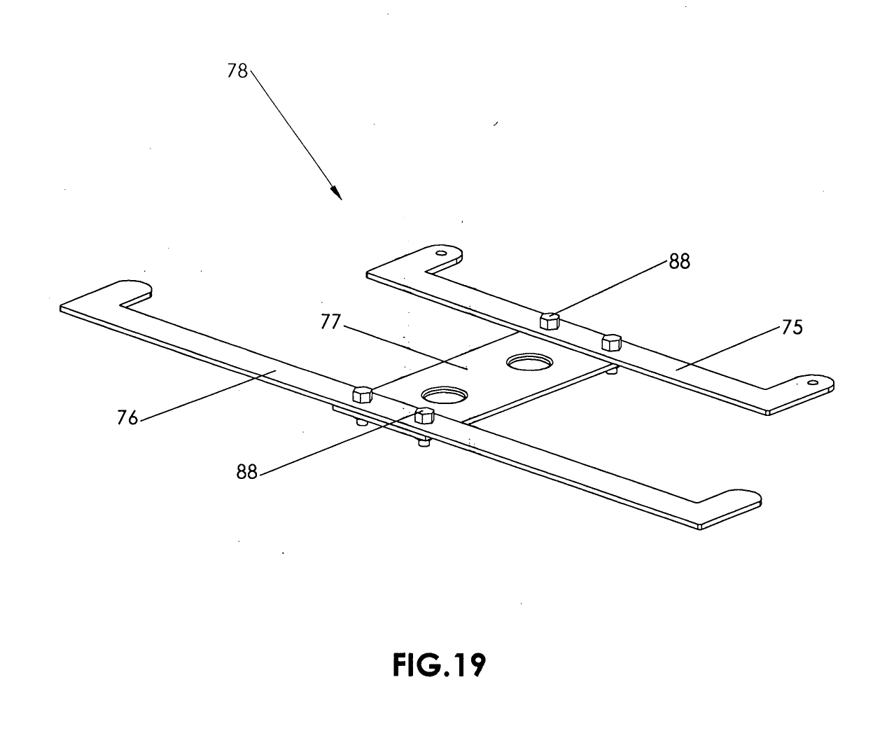

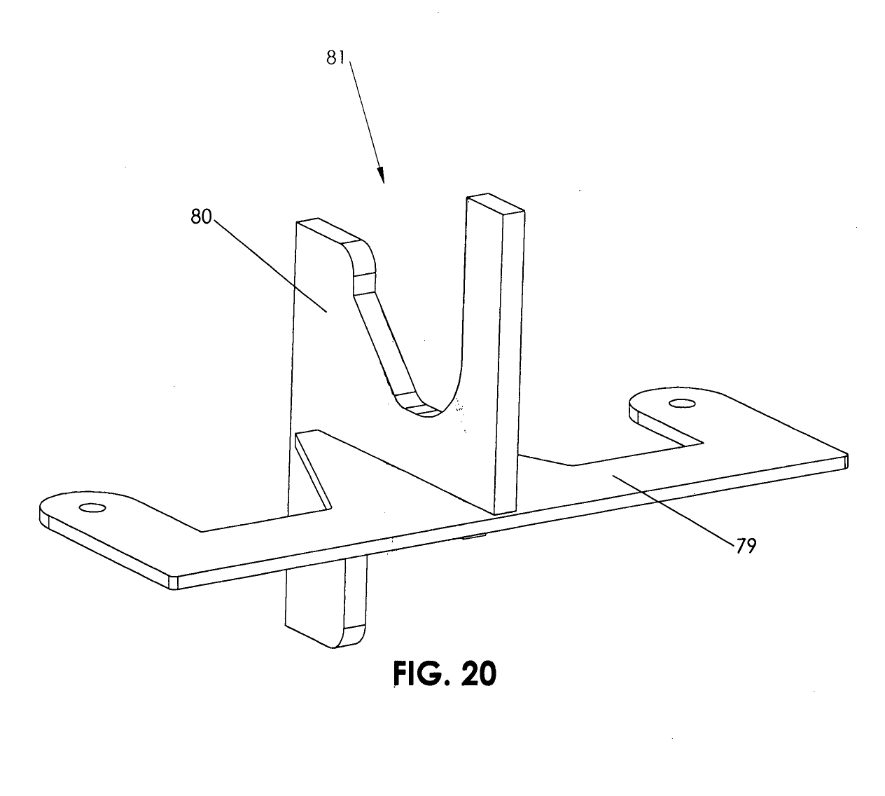

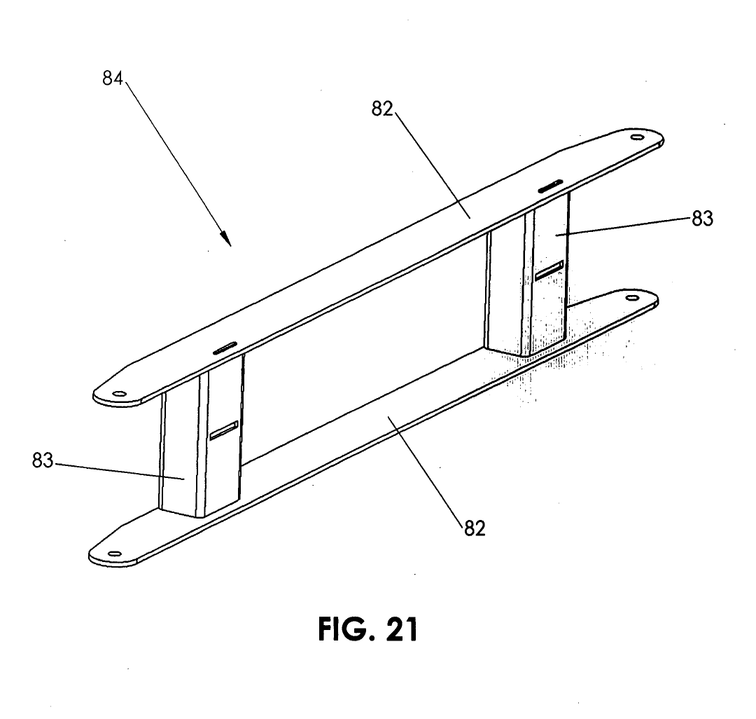

Sill plates 59 and 62 and braces 60, 61 and 63 are fastened together by welding or other means familiar to those skilled in the art to provide a rigid assembly. Similarly, FIG. 16 illustrates the construction of the window frame form right side panel assembly 68 including right window side plate 66, braces 67 and tubing braces 65 which also serve to provide connecting slots for the window frame form cross brace assembly. FIG. 17 illustrates the construction of the window frame form left side panel assembly 69 which is a mirror image of the window frame form right side panel assembly 68. FIG. 18 illustrates the construction of the window frame form top arch panels 74, including a roll formed top arch plate 70 to match the radius of the arch of the window frame to be used in the panel, braces 71, and tubing braces 72 and 73. Tubing brace 72 is provided with a slot for connection to the window frame arch key assembly. Referring to FIG. 19, the construction of the window frame cross brace assembly is shown. It includes upper cross brace 75 and lower cross brace 76 connected to magnet holder plate 77 by fasteners 88. FIG. 20 illustrates the construction of the window frame arch key assembly 81 which includes key plate 80 and key cross brace 79 attached together by welding or other permanent means. The key cross brace 79 is provided with precisely placed holes to allow for assembly with window frame form top arch panel assemblies 74 using alignment pins 85. Referring to FIG. 21, the window frame form spanner brace assembly is constructed using spanner braces 82 and spanner tubes 83. Spanner braces 82 are provided with precisely placed holes which allow for assembly with the window frame form right side panel assembly 68, the window frame form left side panel assembly 69, two window frame form top arch panel assemblies 74, and window frame form cross brace assembly 78 using alignment pins 85, and tying all of these assemblies together into a rigid and precisely aligned unit as shown in FIG. 22.

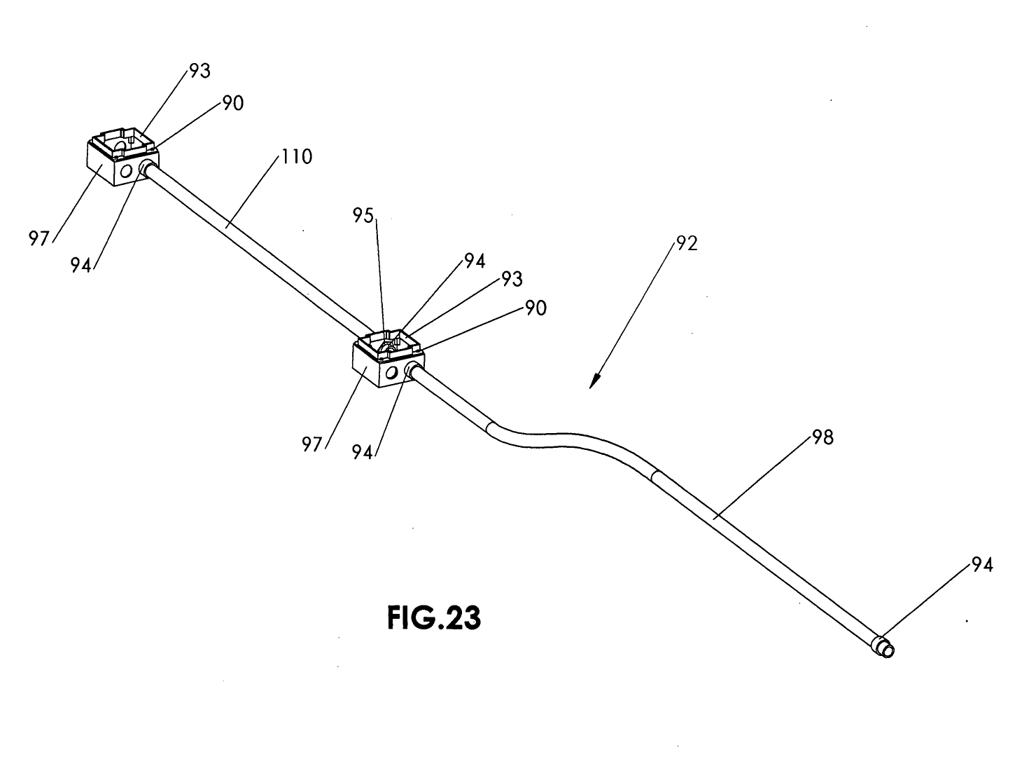

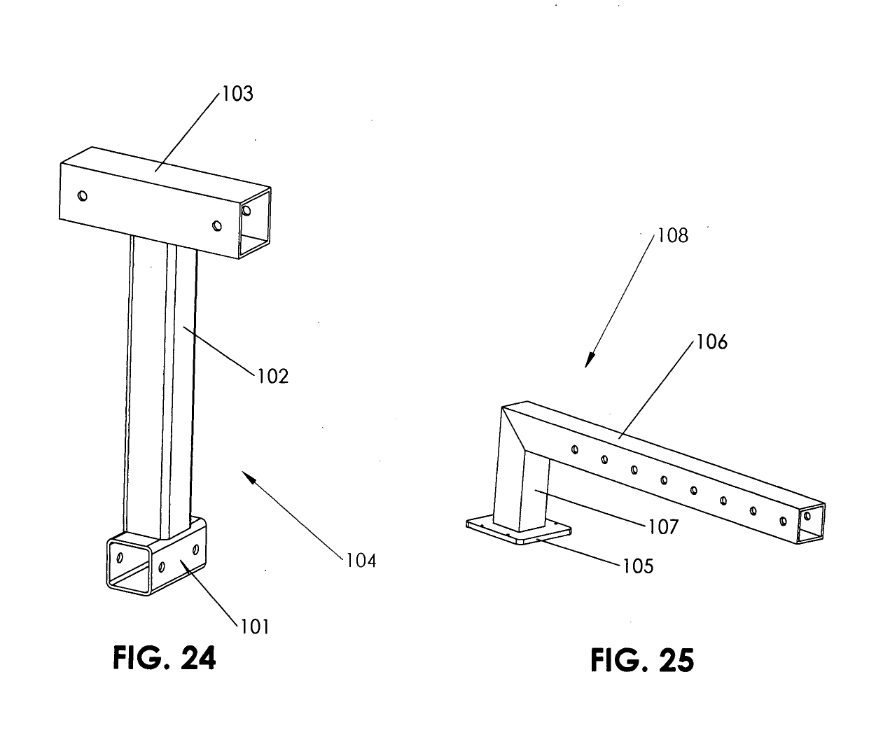

FIG. 23 illustrates a feature of the preferred embodiment that allows for the incorporation of routing of electrical, cable, fiber optic, telephone, or similar type wiring into the finished construction panel. The electrical box and conduit assembly 92 includes tubular conduit 98 which could be any of the rigid or flexible conduit in standard use and familiar to those skilled in the art, couplers 94, electrical switchboxes 97, hardware adapter plates 93, coupler nuts 95, tubular conduit 110 and fasteners 90. All of these components are standard electrical components in use in the industry and familiar to those skilled in the art. It can be readily seen that these components can be assembled into any desired configuration to provide routing for any of the types of wiring above mentioned into the wall or construction panel being formed. In order to position and hold the electrical box and conduit assembly in the desired position in the form of the preferred embodiment while the construction material is poured and sets, FIG. 24 illustrates a bracket 104 constructed of tubes 101, 102 and 103 which attaches to the form with bolts and nuts or other suitable fasteners. FIG. 25 shows a sliding adjustable electrical box holding assembly 108 which is used in conjunction with bracket 104.

Returning now to FIG. 26, one can see how bracket 104 in combination with the sliding adjustable electrical box holding assembly 108 can be used to position and hold the electrical box and conduit assembly 92 at a desired location in the form using bolts 112, nuts 113 and screws 114. FIG. 26 also illustrates how the window frame form 87 is secured to the casting bed in a desired location using magnets 86. A tube 89 of cylindrical material which can be of a substance which can be released from the finished panel by virtue of a release agent, or by virtue of using a low friction material, or by using a material which can be later dissolved from the finished panel provides a vertically running cylindrical void in the finished panel which provides a path for running a connection means through the panel to connect the panel to a foundation, a sill, or to another panel either above or below the existing panel. Additionally, holes are provided in form end wall assemblies 48 for positioning of lifting eye bolts 109 connected to anchors 100 which will end up imbedded in the finished molded panel and serve to provide an attachment for lifting the panel with a crane or other lifting means. As can readily be seen by one skilled in the art, the form 117 can assembled onsite and poured to create a finished wall panel, as in the preferred embodiment, requiring no additional work to add a standard prefabricated window, electrical conduit, or joint seal around the panel. It can also be seen that this method of constructing a form can easily be used to create any type of construction panel, interior or exterior wall panels, with or without doors and windows, roof panels, or any construction shape capable of being poured in a flat form.

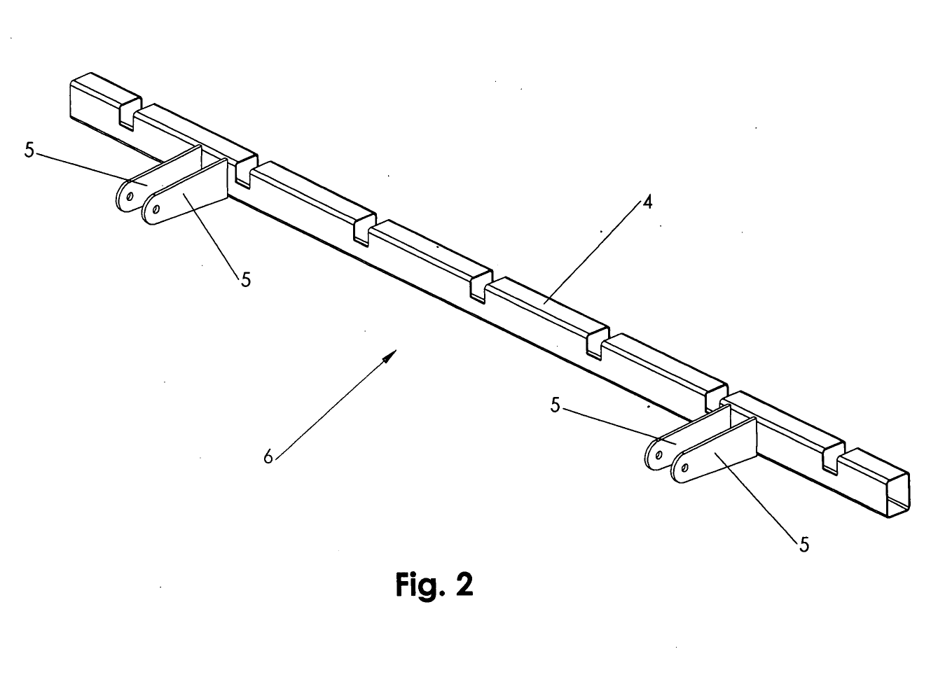

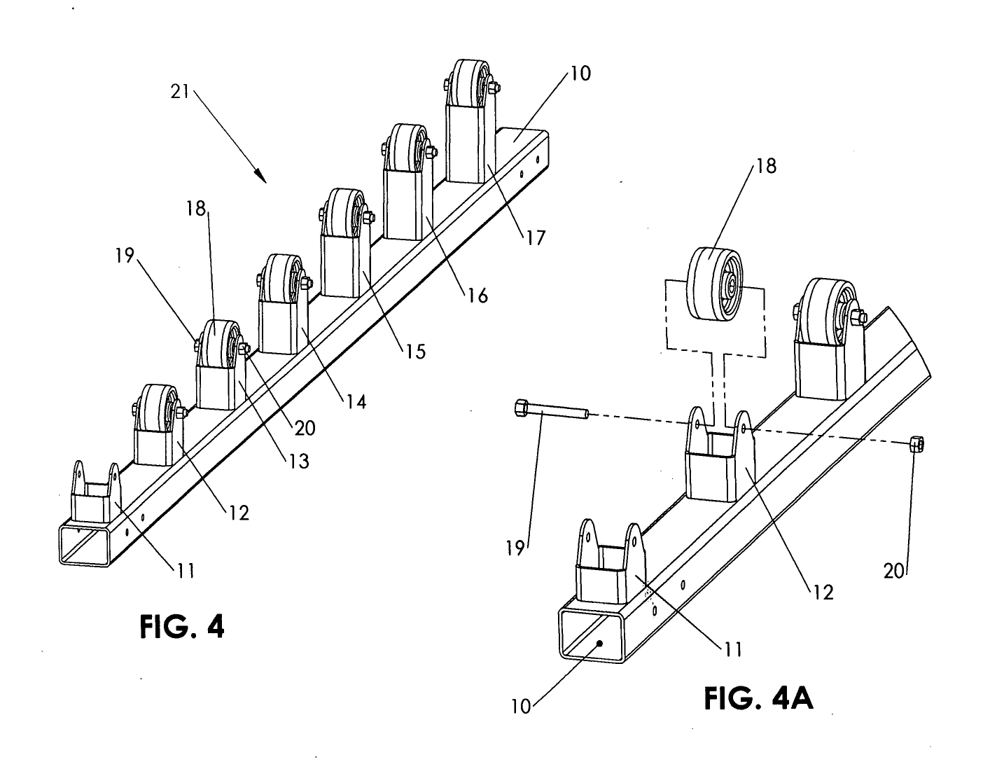

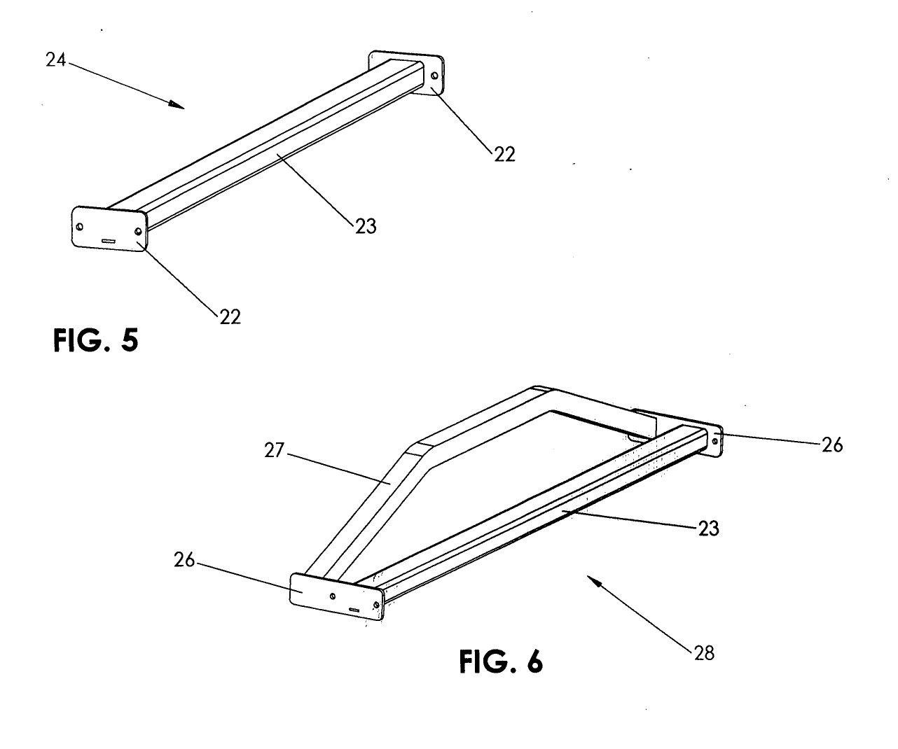

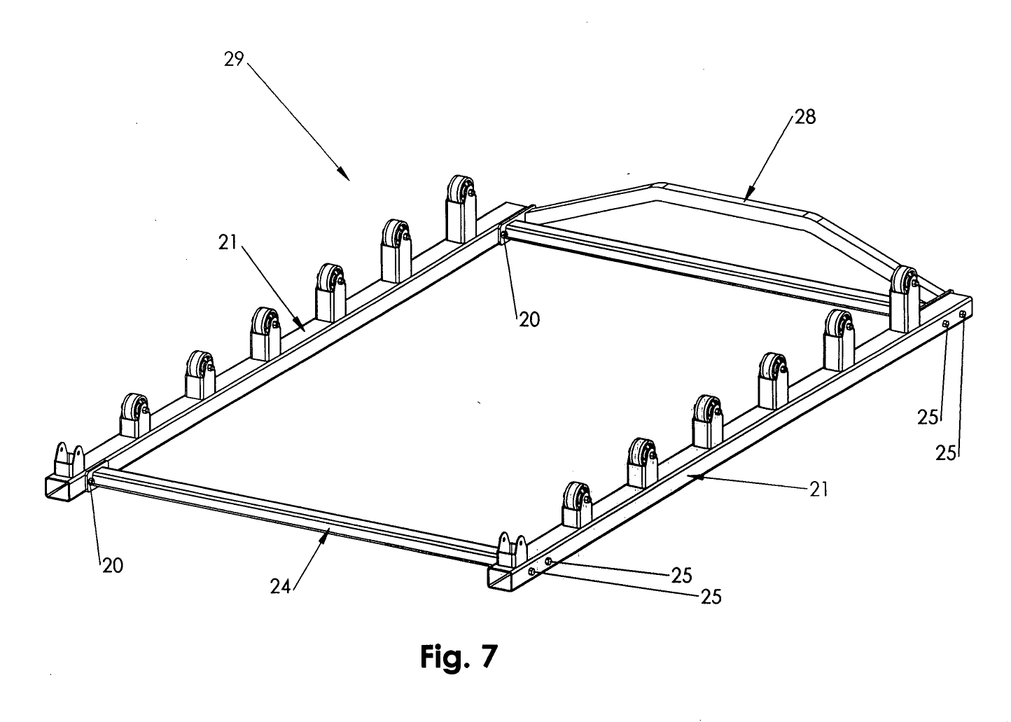

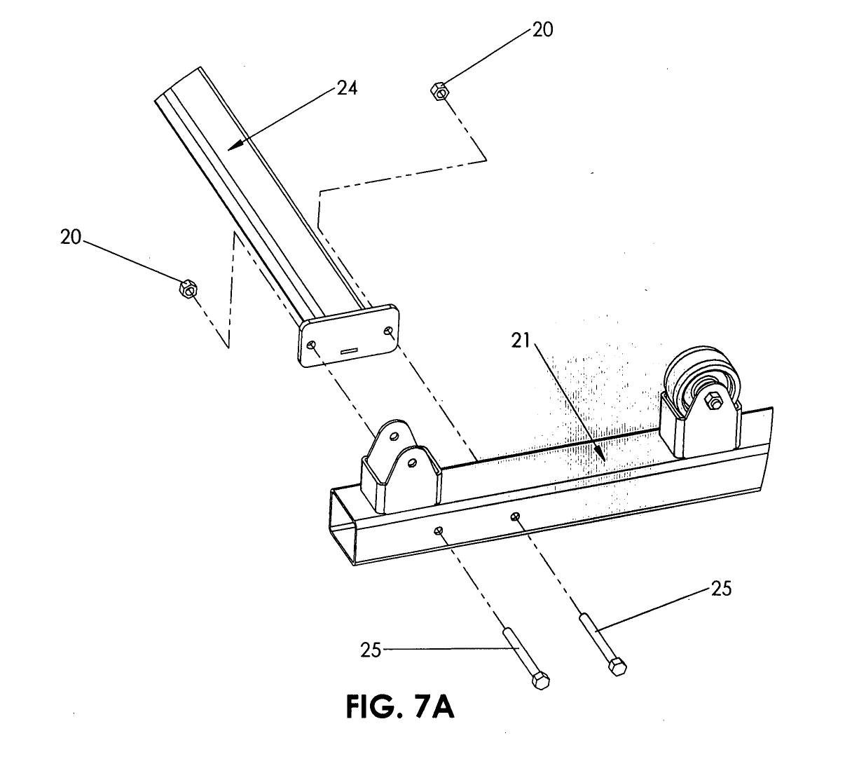

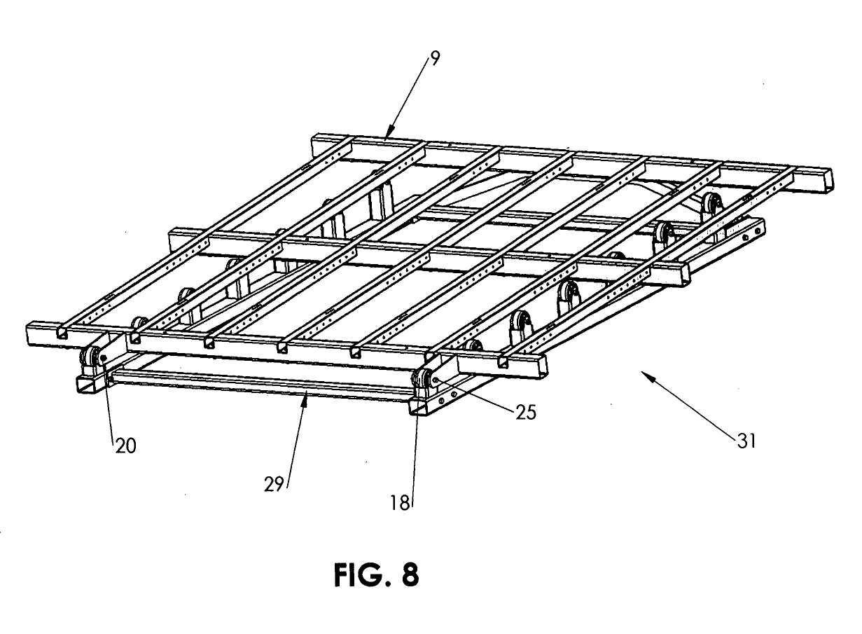

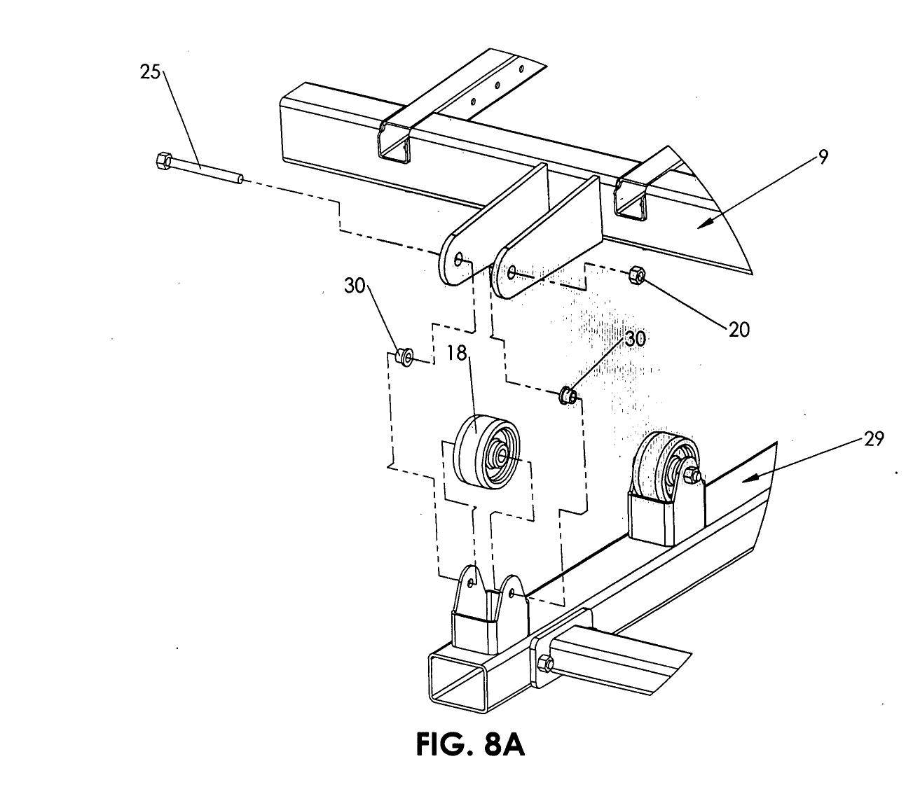

Referring now to FIG. 8, a second preferred embodiment of the invention is shown in which the support bed frame assembly of the first preferred embodiment is replaced with a support bed frame assembly which also includes a horizontal unloading platform. This support bed frame assembly with horizontal unloading platform 31 includes support bed frame assembly 9 hingedly connected to the forward end of horizontal unloading platform 29 with bolts 25 and nuts 20. FIG. 3 illustrates the construction of support bed frame assembly 9 which like the support bed frame assembly of the first preferred embodiment includes frame tube assemblies 3 and frame rail assemblies 7, and further includes frame rail assembly with hinge brackets 6. FIG. 2 shows frame rail assembly with hinge brackets 6 which includes frame rail 4 with precision machined geometry to accept frame tube assemblies and hinge brackets 5 welded to frame rail 4. FIG. 3A illustrates detail of the assembly method of support bed frame assembly 9. FIG. 7 shows horizontal unloading platform 29 including roller frame rail assemblies 21, forward brace 24, and lift support assembly 28 connected together with bolts 25 and nuts 20, although it can be easily seen that other fastening methods could be used. FIG. 4 illustrates the construction of roller frame rail assembly 21 which is constructed of precision machined structural tubing of a suitably strong material, preferably steel to fabricate roller frame rail 10, and roller housings 11, 12, 13, 14, 15, 16, and 17. The roller housings are precisely machined each to the proper height to enable all of the rollers 18 to contact the underside of the casting bed plates at the same time when the horizontal unloading platform is lifted to unload the set construction panel from the form. FIG. 4A shows the detail of the connection of rollers 18 to roller housings and roller frame rail 10 using bolts 19 and nuts 20. FIG. 5 shows tubing 23 and flanges 22 welded together to create forward brace 24. FIG. 6 shows lift support 27, lift brace 23 and flanges 26 welded together to create lift support assembly 28. Detail FIG. 8A illustrates how support bed frame assembly 9 is hingedly attached to horizontal unloading platform 29 using bolts 25 inserted through hinge brackets 5, bushings 30, roller housings 11 and rollers 18, and secured by nuts 20.

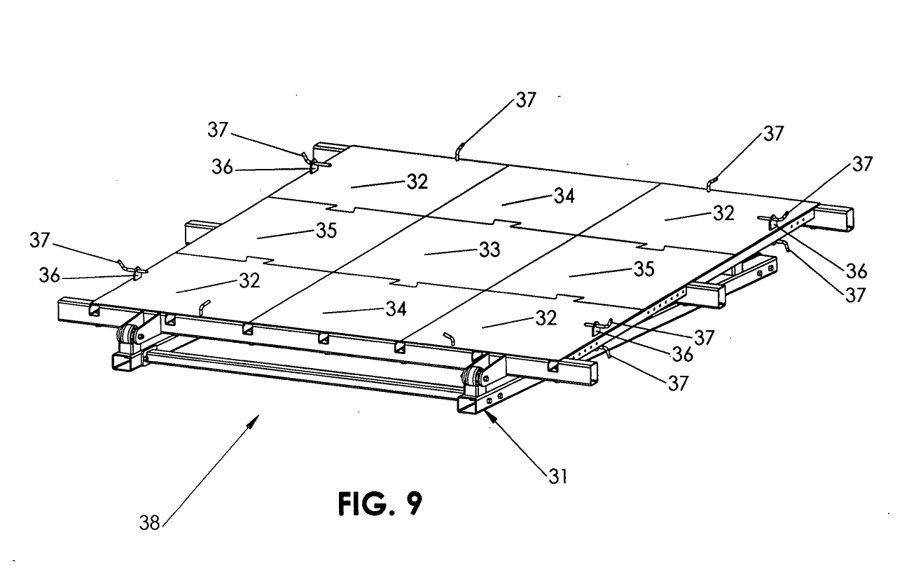

Referring now to FIG. 9, in operation, support bed frame assembly 29 is supported on leveling jacks 40 in the same fashion as shown for the first preferred embodiment in FIG. 10. When ready to unload the set construction panel from the form, after removing form side and end walls, alignment pins 36 are removed, freeing the casting plates from the support bed frame assembly. A lifting force is then applied by a jack or other lifting means to lift brace 23, rotating horizontal unloading platform 29 upward about its hinged attachment causing rollers 18 to contact the underside of casting bed plates 32 and 35 lifting them along with the set panel upward at an angle allowing gravity to roll the set panel forward off of the platform. In this way, the form can be used many times, and many panels can be molded and unloaded without the necessity of having a crane or other heavy lifting equipment employed until it is required to move the panels into place for their final location in the construction project.

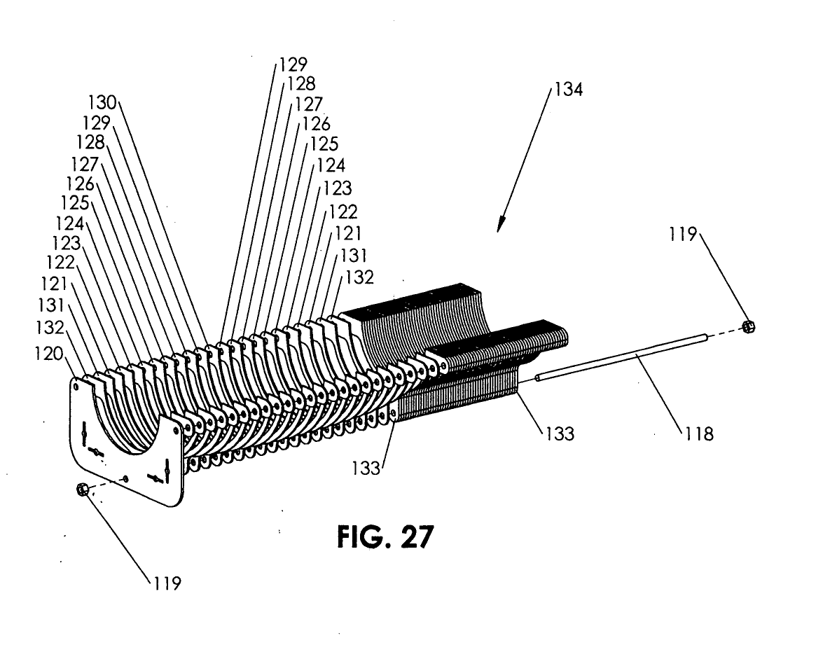

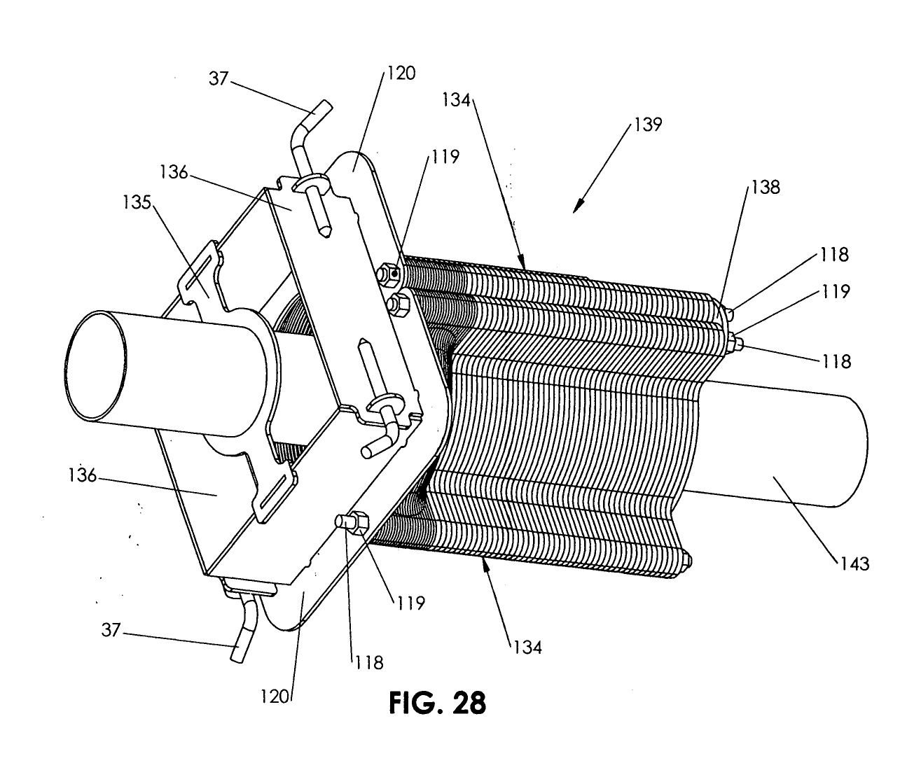

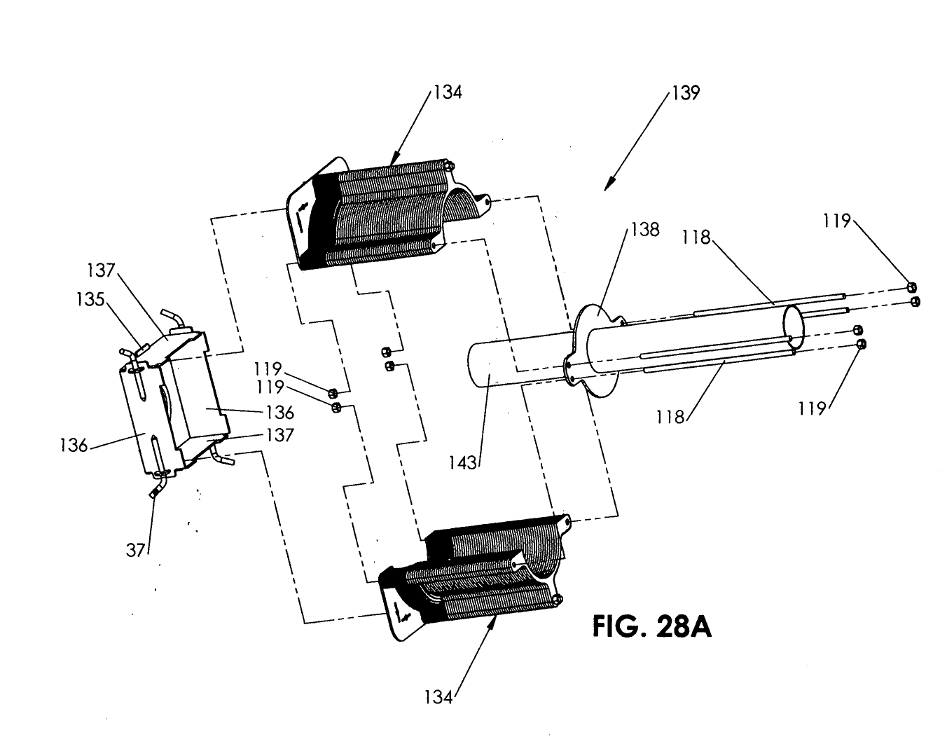

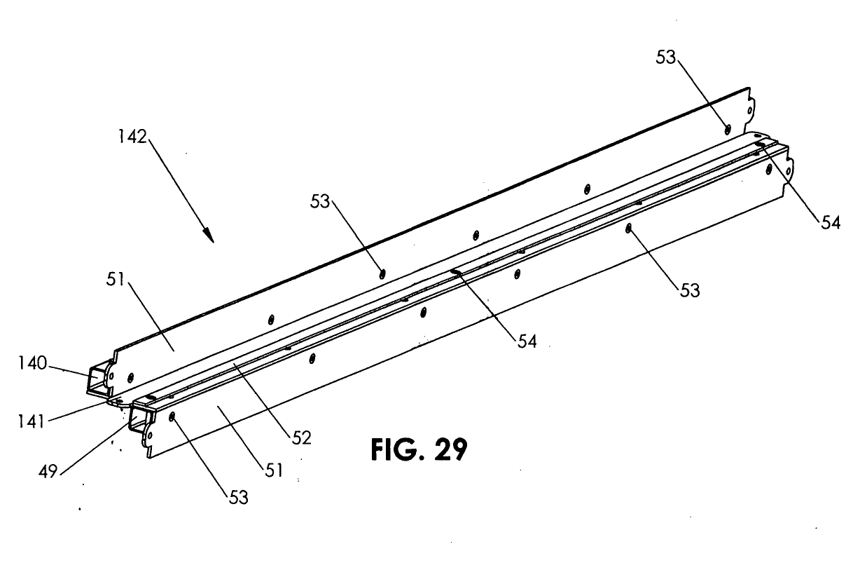

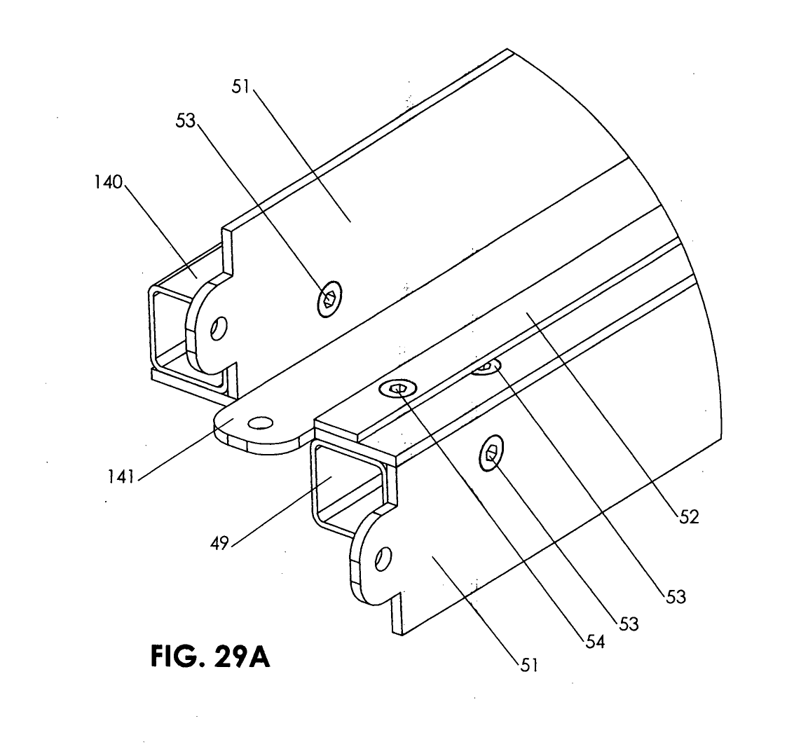

Referring now to FIG. 29, in a third preferred embodiment, the form of the first preferred embodiment further includes improved form end wall assemblies 142, replacing the form end wall panel assemblies 48 and the form lap joint assemblies 47 of the first preferred embodiment with improved form end wall assemblies 142. The improved form end wall assemblies 142 combine the features of the two elements of the first preferred embodiment into one element, with the further added versatility of allowing the length of the finished panel to be adjusted to varying lengths by choosing the placement of the improved form end wall assemblies 142 into varying positions with varying distances between them disposed on the casting bed between form side wall panel assemblies 45. The improved form end wall assemblies also can be placed in either an upward orientation or a downward orientation, thereby creating the same lap joint functionality of the form lap joint assemblies 47 of the first embodiment. The improved form end wall assembly 142 also includes the groove forming strip 52 providing a groove in the finished panel for a bead of sealing material to provide for a weathertight seal between assembled panels. The improved form end wall assembly is constructed from precision machined plates 51 and 141 connected to precision machined structural tubing 49 and 140, and groove forming strip 52 using flat head bolts 53 and 54 secured by nuts 55. Detail of this construction is shown in FIG. 29A. A fourth preferred embodiment of the invention utilizes the same method of computer controlled precision machining of individual components of the form in order to enable these components to fit together precisely and encompass the finished volume of the desired construction element even though the element has a complex shape or contour. In this fourth preferred embodiment, a form is created to produce a column having a cylindrical cross section of varying radius with a pedestal having a square cross section. Referring to FIG. 28, the form 139 is shown fully assembled, comprising components precision machined utilizing computer controlled laser cutting, computer controlled water jet cutting, computer controlled plasma cutting or other similar technology as will be familiar to those skilled in the art, from a suitable material, preferably steel, including end plate 138, straight column section plates 134, contoured column section plates 120-133, pedestal top plates 120, pedestal slotted side plates 136, pedestal tabbed side plates 137, center tube alignment plate 135, and center tube 143. These parts are assembled and held together in precise alignment by virtue of the precisely positioned and dimensioned holes provided in these parts by running threaded alignment rods 118 through the holes provided and securing with nuts 119. Pedestal tabbed side plates 137 are attached to pedestal slotted side plates 136 by inserting tabs of 137 through slots of 136 and securing with alignment pins 37. Assembled pedestal side plates 136 and 137 are then assembled to pedestal top plates 120 and held in place with clamps or other suitable fasteners. Center tube alignment plate 135 is assembled to pedestal side plates 137 and secured with clamps or fasteners, and center tube 143 is inserted through center tube alignment plate 135, through the inside of the form, and out through end plate 138. Detail of the assembly is shown in FIG. 27 and FIG. 28A. In operation, the form is held in position with the pedestal end upward and poured through the open end of the pedestal. When the construction material is set, the form can be disassembled by removing alignment pins 37, nuts 119 and threaded alignment rods 118. Plates can then be removed leaving the contoured cylindrical shaped column with pedestal construction element intact and ready for placement in a structure. Center tube 143 normally is left in the column to serve as structural reinforcement for the column. While this fourth preferred embodiment of the invention is used to form a column, it can be easily seen by one skilled in the art that this method can be used to produce a form for the creation of virtually any complex contoured shape merely by altering the contour of the interior cut of the stacked up plates used in the form. In common with the other embodiments of the invention, this method produces a form which is portable, easily assembled on site for use, easily disassembled for demolding the finished construction element, and then easily reassembled for reuse.

It can be seen that in each of these preferred embodiments that standard reinforcing members can be used as in conventional forms in order to reinforce the poured construction material whether it be lightweight concrete, cellular concrete, concrete, or other poured construction material any of which can be used in the forms of this invention.

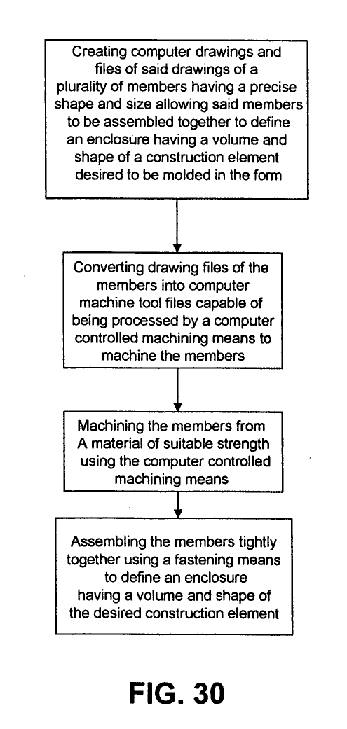

Referring to FIG. 30, the flow chart diagram illustrates the steps included in the method employed in fabricating the form of the current invention which comprises creating computer drawings and files of the members of the desired form, then converting the drawing files to computer machine tool files capable of being processed by computer controlled machining equipment to precisely create the members of the form from these files, machining these members of a suitable material having sufficient strength to withstand the weight and pressures of the form and the construction material to be poured into the form, assembling the members using conventional fabricating techniques including using bolts and nuts, clamps, tabs, slots and pins, or other fastening means, to create an enclosure or cavity and frame with which to support it, which will hold a construction material which can be poured into the enclosure or cavity until it is set, then be disassembled to unload the finished panel and reassembled to pour another panel or to be portably removed to another job site or for storage. The form can thus be used indefinitely as long as it is properly maintained and is not damaged. Since the components of the form are created from computer files, they can be re-created precisely if needed for replacement of damaged or lost components.

What is claimed is:

1. A form for molding a construction element, said form comprising:
(a) an enclosure formed by a plurality of precision machined members assembled tightly together, said enclosure defining a volume and shape of the construction element desired to be molded, wherein said precision machined members are made of a material of sufficient strength to resist deformation from the pressure of a construction material intended to be poured into said enclosure;
(b) an opening in the enclosure, wherein a construction material can be introduced into the enclosure;
(c) a fastening means for fastening said precision machined members together, whereby the members are held together while the construction material hardens;

2. The form for molding a construction element as claimed in claim 1, wherein the precision machined members are precision machined using computer controlled laser cutting machinery.

3. The form for molding a construction element as claimed in claim 1, wherein the precision machined members are precision machined using computer controlled water jet cutting machinery.

4. The form for molding a construction element as claimed in claim 1, wherein the precision machined members are precision machined using computer controlled plasma cutting machinery.

5. The form for molding a construction element as claimed in claim 1, wherein the precision machined members are made of steel.

6. The form for molding a construction element as claimed in claim 1, wherein the fastening means provides for the capability of being non-destructively unfastened.

7. The form for molding a construction element as claimed in claim 1, further including leveling means for holding the form in a level orientation.

8. The form for molding a construction element as claimed in claim 1, further including a liner, said liner having a texture and being of a size and shape to cover at least one surface of the form into which the construction material will come into contact.

9. The form for molding a construction element as claimed in claim 1, further including a horizontal unloading means, wherein the construction element can be unloaded from the form after the construction material hardens.

10. The form for molding a construction element as claimed in claim 1, further including a plurality of additional enclosures formed by a plurality of precision machined members assembled tightly together, said additional enclosures defining shapes and volumes disposed within the form, wherein the construction material is excluded from entering the shapes and volumes created by said additional enclosures, whereby an opening is formed in the construction element after the construction material hardens.

11. The form for molding a construction element as claimed in claim 1, further including a plurality of adjustable precision machined members, wherein said adjustable precision machined members can be movably positioned, whereby the shape and volume of the enclosure can be varied according to the chosen placement of the adjustable precision machined members in the form.

12. The form for molding a construction element as claimed in claim 1, further including a plurality of precision machined groove forming strips disposed around an inside perimeter defined by the enclosure, the strips being of a suitable shape and dimension to exclude the construction material from a groove shaped perimeter around the construction element, whereby a groove is formed in the construction element to allow for placement of a bead of sealing material around the perimeter of the construction element.

13. The form for molding a construction element as claimed in claim 1, further including a plurality of precision machined holes in a plurality of the precision machined members forming the enclosure, wherein a plurality of electrical conduit and switchbox assemblies can be positioned inside of the enclosure, and a holding means for holding said electrical conduit and switchbox assemblies in place.

14. The form for molding a construction element as claimed in claim 1, further including a plurality of precision machined holes in a plurality of the precision machined members forming the enclosure, said precision machined holes being disposed in the members to allow for the insertion of a plurality of tubes extending completely through the volume of the enclosure.

15. A form for molding a construction element, said form comprising:
a frame, said frame being formed by a plurality of precision machined members and having an upper surface disposed levelly to support a casting bed placed thereon and connected thereto by a first fastening means, said casting bed being made of a plurality of precision machined plates interlocking together to form a matrix of said precision machined plates, wherein spacing between the plates is sufficiently small to prevent the passage of a construction material intended to be used in the form, said form further comprising a plurality of precision machined panels, disposed upwardly from and connected to the casting bed by a second fastening means, wherein the panels together with the casting bed form an enclosure, said enclosure having an opening, wherein a construction material can be introduced into the enclosure, and said precision machined members, said precision machined plates, and said precision machined panels are made of a material of sufficient strength to resist deformation from the pressure of a construction material intended to be poured into said enclosure, and wherein said precision machined members, said precision machined plates, and said precision machined panels are precisely dimensioned such that when assembled together they define an enclosure having a volume and shape of the construction element desired to be molded.

16. The form for molding a construction element as claimed in claim 15, wherein the precision machined members, the precision machined plates, and the precision machined panels are precision machined using computer controlled laser cutting machinery.

17. The form for molding a construction element as claimed in claim 15, wherein the precision machined members, the precision machined plates, and the precision machined panels are precision machined using computer controlled water jet cutting machinery.

18. The form for molding a construction element as claimed in claim 15, wherein the precision machined members, the precision machined plates, and the precision machined panels are precision machined using computer controlled plasma cutting machinery.

19. The form for molding a construction element as claimed in claim 15, wherein the precision machined members, the precision machined plates, and the precision machined panels are made of steel.

20. The form for molding a construction element as claimed in claim 15, wherein the first fastening means and the second fastening means provide for the capability of being non-destructively unfastened.

21. The form for molding a construction element as claimed in claim 15, further including leveling means for holding the form in a level orientation.

22. The form for molding a construction element as claimed in claim 15, further including a liner, said liner having a texture and being of a size and shape to fit within the enclosure formed by the precision machined panels and the casting bed, said liner being disposed within the enclosure to cover at least one surface of the form into which the construction material will come into contact.

23. The form for molding a construction element as claimed in claim 15, further including a horizontal unloading means, wherein the construction element can be unloaded from the form after the construction material hardens.

24. The form for molding a construction element as claimed in claim 15, further including a plurality of additional enclosures formed by a plurality of precision machined members assembled tightly together, said additional enclosures defining shapes and volumes disposed within the form, wherein the construction material is excluded from entering the shapes and volumes created by said additional enclosures, whereby a plurality of openings are formed in the construction element after the construction material hardens.

25. The form for molding a construction element as claimed in claim 15, further including a plurality of adjustable precision machined panels, wherein said adjustable precision machined panels can be movably positioned, whereby the shape and volume of the enclosure can be varied according to the chosen placement of the adjustable precision machined panels in the form.

26. The form for molding a construction element as claimed in claim 15, further including a plurality of precision machined groove forming strips disposed around an inside perimeter defined by the enclosure, the strips being of a suitable shape and dimension to exclude the construction material from a groove shaped perimeter around the construction element, whereby a groove is formed in the construction element to allow for placement of a bead of sealing material around the perimeter of the construction element.

27. The form for molding a construction element as claimed in claim 15, further including a plurality of precision machined holes in a plurality of the precision machined panels forming the enclosure, wherein a plurality of electrical conduit and switchbox assemblies can be positioned inside of the enclosure, and a holding means for holding said electrical conduit and switchbox assemblies in place.

28. The form for molding a construction element as claimed in claim 1, further including a plurality of precision machined holes in a plurality of the precision machined panels forming the enclosure, said precision machined holes being disposed in the panels to allow for the insertion of a plurality of tubes extending completely through the volume of the enclosure.

29. A method for fabricating a form for molding a construction element comprising:
(a) creating computer drawings and files of said drawings of a plurality of members having a precise shape and size allowing said members to be assembled together to define an enclosure having a volume and shape of a construction element desired to be molded in the form;
(b) converting said files of said drawings into computer machine tool files capable of being processed by a computer controlled machining means to machine the members;
(c) machining the members from a material of suitable strength to resist the weight of the form and the pressure of a construction material to be poured into the form without deformation using a computer controlled machining means;
(d) assembling the members tightly together using a fastening means to define an enclosure having a volume and shape of the construction element to be molded in the form.

30. The method for fabricating a form for molding a construction element as claimed in claim 29, wherein the computer controlled machining means is computer controlled laser cutting machinery.

31. The method for fabricating a form for molding a construction element as claimed in claim 29, wherein the computer controlled machining means is computer controlled water jet cutting machinery.

32. The method for fabricating a form for molding a construction element as claimed in claim 29, wherein the computer controlled machining means is computer controlled plasma cutting machinery.

33. The method for fabricating a form for molding a construction element as claimed in claim 29, wherein the fastening means utilizes fasteners capable of being non-destructively unfastened, whereby the form can be repeatedly dis-assembled and re-assembled.
